(19) United States
(12) Patent Application Publication
(10) Pub. No.: US 2023/0370152 A1
(43) Pub. Date: Nov. 16, 2023

(54) Technique for Radio Resource Allocation in a Relayed Radio Communication

(71) Applicant: Telefonaktiebolaget LM Ericsson (publ), Stockholm (SE)

(72) Inventor: Min Wang, Luleå (SE)

(21) Appl. No.: 18/026,234

(22) PCT Filed: Sep. 21, 2021
(86) PCT No.: PCT/EP2021/075971

§ 371 Date: Mar. 14, 2023

Related U.S. Application Data
(60) Provisional application No. 63/083,503, filed on Sep. 25, 2020.

(51) Int. Cl. H04B 7/155; H04L 5/00; H04W 72/51

(52) U.S. Cl. CPC H04B 7/15542; H04L 5/0033; H04L 5/0048; H04L 5/0053; H04L 5/0091; H04W 72/51

(57) ABSTRACT

A technique for radio resource allocation in a relayed radio communication is described. One aspect of the technique relates to a method for receiving a radio resource allocation at a relay radio device (100-RL) for at least one remote radio device (100-RM) in relayed radio communication with a radio access network, RAN (100-NN), or a further radio device (100-NN) through the relay radio device (100-RL). At the relay radio device (100-RL), a control message is received (204-RL), which is indicative of radio resources allocated to a device-to-device (D2D) communication between the at least one remote radio device (100-RM) and the relay radio device (100-RL).

### TECHNICAL FIELD

The present disclosure relates to a technique for radio resource allocation in a relayed radio communication. More specifically, and without limitation, methods and devices are provided for receiving and transmitting a radio resource allocation for at least one remote radio device in relayed radio communication with a radio access network (RAN) or a further radio device through a relay radio device.

### BACKGROUND

The Third Generation Partnership Project (3GPP) and the Wi-Fi Alliance specify radio access technologies such as Fourth Generation Long Term Evolution (4G LTE), Fifth Generation New Radio (5G NR) and Wi-Fi, each of which supports device-to-device (D2D) communications. For example, 3GPP has specified sidelink (SL) for LTE and NR. These are also referred to as proximity services (or PROximity-based Services, ProSe).

In a relay scenario, in case a relay UE has coverage to a base station (e.g., a gNB), the gNB can assign a resource to the relay UE (i.e., via Mode 1 resource allocation). However, for a remote UE, the gNB has less flexibility regarding resource allocation of sidelink transmissions. The remote UE has no direct connection to the gNB. Therefore, the gNB cannot perform ordinary dynamic scheduling using a downlink control information (DCI) signaling. Meanwhile, the gNB will not be able to assign a Type 2 configured grant to the remote UE using a direct DCI signaling. The gNB may be able to signal a Type 1 configured grant using RRC signaling to a remote UE in case the remote UE is connected to the gNB via a L2 relay.

However, such resource allocation is not resource efficient, especially when the UE has varying SL channel quality.

### SUMMARY

Accordingly, there is a need for a technique that improves the radio resource allocation for a remote radio device in sidelink (SL) transmissions of a relayed radio communication. Alternatively or in addition there is a need for a technique that improves on the flexibility of a radio resource allocation of a remote radio device. Further alternatively or in addition, there is a need for a technique that improves the efficiency of radio resource utilization and/or avoids collisions and/or congestion in the presence of multiple remote radio devices.

As to a first method aspect, a method of receiving a radio resource allocation at a relay radio device for at least one remote radio device in relayed radio communication with a radio access network (RAN) or a further radio device through the relay radio device is provided. The method may comprise or initiate a step of receiving, at the relay radio device, a control message indicative of radio resources allocated to a device-to-device (D2D) communication between the at least one remote radio device and the relay radio device.

The technique may be implemented as a method of controlling the allocation of the radio resources for the at least one remote radio device in relayed radio communication, e.g., by a network node (e.g., a base station) of the RAN or the further radio device.

The relay radio device may relay scheduling (e.g., as received in the control message) from the RAN or the further radio device to the remote radio device. The relayed scheduling may comprise dynamic scheduling or configured grants. Alternatively or in addition, the relay radio device may relay a scheduling request (SR) and/or a buffer status report (BSR).

According to a first embodiment (e.g., of the first aspect), for a remote radio device (e.g. UE) connecting to a relay radio device (e.g., UE) which has coverage to a RAN (e.g., gNB), the RAN (e.g., gNB) may assign grants to the remote radio device (e.g., UE) via the relay radio device (e.g., UE).

According to the first embodiment, the RAN (e.g., gNB) learns that the remote radio device (e.g., UE) demands resources for the SL between the remote radio device (e.g., UE) and the relay radio device (e.g., UE). Since the remote radio device (e.g., UE) may have no direct connection to the RAN (e.g., gNB), the RAN (e.g., gNB) may not be able to assign resources to the remote radio device (e.g., UE) via a direct downlink (DL) signaling. In such as case, the RAN (e.g., gNB) may assign a grant to the remote radio device (e.g., UE) via the relay radio device (e.g., UE).

The first method aspect may be implemented alone or in combination with any one of the claims, particularly the claims 1 to 24.

As to a second method aspect, a method of transmitting a radio resource allocation to a relay radio device for at least one remote radio device in relayed radio communication with a radio access network (RAN) or a further radio device through the relay radio device is provided. The method may comprise or initiate a step of allocating radio resources to a device-to-device (D2D) communication between the at least one remote radio device and the relay radio device. The method further comprises or initiates a step of transmitting, to the relay radio device, a control message indicative of the radio resources allocated to the D2D communication between the at least one remote radio device and the relay radio device.

The second method aspect may be implemented alone or in combination with any one of the claims, particularly the claims 25 to 27.

The second method aspect may further comprise any feature, or may comprise or initiate any step, disclosed in the context of the first method aspect or may comprise a feature or step corresponding thereto. For example, the relay radio device may transmit a capability message indicating that the relay radio device is capable of relaying an allocation of radio resources and/or is capable of sharing allocated radio resources to RAN, and the RAN may receive the corresponding capability message from the relay radio device.

As to a third method aspect, a method of receiving a radio resource allocation from a relay radio device at a remote radio device in relayed radio communication with a radio access network (RAN) or a further radio device through the relay radio device is provided. The method comprises or initiates a step of receiving, at the remote radio device from the relay radio device, at least one of a grant for a data transmission from the remote radio device to the relay radio device in the relayed radio communication and a scheduling assignment for a data reception from the relay radio device at the remote radio device in the relayed radio communication.

According to a second embodiment (e.g., of the third aspect), for a remote radio device (e.g., UE) connecting to a relay radio device (e.g., UE) which has coverage to a RAN (e.g., gNB), the RAN (e.g., gNB) may assign a grant which can be shared between the relay radio device (e.g., UE) and the remote radio device (e.g., UE). In case the remote radio device (e.g., UE) has no direct connection to the RAN (e.g., gNB), the RAN (e.g., gNB) may signal the grant to the relay radio device (e.g., UE) via system information, dedicated RRC signaling, MAC CE or DCI.

Grant sharing may be performed given the fact that bi-directional traffic is typically carried on a SL RB between the relay radio device (e.g., UE) and the remote radio device (e.g., UE). The relay radio device (e.g., UE) and the remote radio device (e.g., UE) will not transmit on the SL RB at the same time. Whenever the remote radio device (e.g., UE) transmits a packet to the relay radio device (e.g., UE), the relay radio device (e.g., UE) needs to provide an acknowledgement (e.g., an ACK) on the reverse link.

The third method aspect may be implemented alone or in combination with any one of the claims, particularly the claims 28 to 30.

The third method aspect may further comprise any feature, or may comprise or initiate any step, disclosed in the context of the first method aspect or may comprise a feature or step corresponding thereto. For example, responsive to the reception of a data transmission from the remote radio device for relay to the RAN by the relay radio device, the relay radio device may transmit an acknowledgement to the remote radio device, which the remote radio device may receive.

Moreover, the first method aspect may be performed at or by a transmitting station (briefly: transmitter), e.g., a base station for a downlink or a radio device for an uplink or a sidelink connection. Alternatively, or in combination, the second method aspect may be performed at or by a receiving station (briefly: receiver), e.g., a base station for an uplink or a radio device for a downlink or a sidelink connection.

The channel or link used for the data transmission and the radio reception, i.e., the channel between the transmitter and the receiver may comprise multiple subchannels or subcarriers (as a frequency domain). Alternatively, or in addition, the channel or link may comprise one or more slots for a plurality of modulation symbols (as a time domain). Alternatively, or in addition, the channel or link may comprise a directional transmission (also: beamforming transmission) at the transmitter, a directional reception (also: beamforming reception) at the receiver or a multiple-input multiple-output (MIMO) channel with two or more spatial streams (as a spatial domain).

The transmitter and the receiver may be spaced apart. The transmitter and the receiver may be in data or signal communication exclusively by means of the radio communication.

In any aspect, the transmitter and the receiver may form, or may be part of, a radio network, e.g., according to the Third Generation Partnership Project (3GPP) or according to the standard family IEEE 802.11 (Wi-Fi). The radio network may be a radio access network (RAN) comprising one or more base stations. Alternatively, or in addition, the radio network may be a vehicular, ad hoc and/or mesh network. The first method aspect may be performed by one or more embodiments of the transmitter in the radio network. The second method aspect may be performed by one or more embodiments of the receiver in the radio network.

Any of the radio devices may be a mobile or wireless device, e.g., a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Any of the radio devices may be wirelessly connected or connectable (e.g., according to a radio resource control, RRC, state or active mode) with any of the base stations. Herein, the base station may encompass any station that is configured to provide radio access to any of the radio devices. The base stations may also be referred to as transmission and reception point (TRP), radio access node or access point (AP). The base station or one of the radio devices functioning as a gateway (e.g., between the radio network and the RAN and/or the Internet) may provide a data link to a host computer providing the data. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer and/or a Radio Resource Control (RRC) layer of a protocol stack for the radio communication.

As to another aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

First device aspects may be provided or implemented alone or in combination with any one of the claims, particularly the claim 32 to 33 or 38 to 39 or 44 or 45. Furthermore, any of the first device aspects may be provided or implemented alone or in combination with any one of the embodiments described hereinbelow.

The device may be configured to perform any one of the steps of the first method aspect.

Second device aspects may be provided or implemented alone or in combination with any one of the embodiments in the list of embodiments, particularly the embodiments 34 to 35 or 40 to 41 or 44 or 45. Furthermore, each of the second device aspects may be provided or implemented alone or in combination with any one of the embodiments described hereinbelow.

The device may be configured to perform any one of the steps of the second method aspect.

Third device aspects may be provided or implemented alone or in combination with any one of the embodiments in the list of embodiments, particularly the embodiments 36 to 38 or 42 to 43 or 45. Furthermore, any of the third device aspects may be provided or implemented alone or in combination with any one of the embodiments described hereinbelow.

The device may be configured to perform any one of the steps of the third method aspect.

As to a still further aspect a communication system including a host computer is provided. The host computer may comprise a processing circuitry configured to provide user data, e.g., depending on the location of the UE determined in the locating step. The host computer may further comprise a communication interface configured to forward user data to a cellular network for transmission to a user equipment (UE), wherein the UE comprises a radio interface and processing circuitry, a processing circuitry of the cellular network being configured to execute any one of the steps of the first and/or second and/or third method aspect.

The communication system may further include the UE. Alternatively, or in addition, the cellular network may further include one or more base stations and/or gateways configured to communicate with the UE and/or to provide a data link between the UE and the host computer using the first method aspect and/or the second method aspect.

The processing circuitry of the host computer may be configured to execute a host application, thereby providing the user data and/or any host computer functionality described herein. Alternatively, or in addition, the processing circuitry of the UE may be configured to execute a client application associated with the host application.

Any one of the devices, the UE, the base station, the system or any node or station for embodying the technique may further include any feature disclosed in the context of the method aspects, and vice versa. Particularly, any one of the units and modules, or a dedicated unit or module, may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1A shows an example schematic block diagram of a device for receiving a radio resource allocation at a relay (RL) radio device for at least one remote (RM) radio device in relayed radio communication with a RAN or a further radio device through the relay radio device;

FIG. 1B shows an example schematic block diagram of a device for transmitting a radio resource allocation to a RL radio device for at least one RM radio device in relayed radio communication with a RAN or a further radio device through the RL radio device;

FIG. 1C shows an example schematic block diagram of a device for receiving a radio resource allocation from a RL radio device at a RM radio device in relayed radio communication with a RAN or a further radio device through the relay radio device;

FIG. 2A shows an example flowchart for a method of receiving a radio resource allocation at a RL radio device for at least one RM radio device in relayed radio communication with a RAN or a further radio device through the relay radio device, which method may be implementable by the device of FIG. 1A;

FIG. 2B shows an example flowchart for a method of transmitting a radio resource allocation to a RL radio device for at least one RM radio device in relayed radio communication with a RAN or a further radio device through the RL radio device, which method may be implementable by the device of FIG. 1B;

FIG. 2C shows an example flowchart for a method of receiving a radio resource allocation from a RL radio device at a RM radio device in relayed radio communication with a RAN or a further radio device through the relay radio device, which method may be implementable by the device of FIG. 1C;

FIG. 3 shows an example deployment scenario for a relayed radio communication;

FIG. 4 schematically shows a physical resource grid of a 3GPP NR implementation;

FIG. 5 schematically illustrates an architecture of a relayed radio communication using a RL device, e.g. as the device of FIG. 1;

FIG. 6 schematically illustrates examples of protocol stacks for a L3 remote radio device-to-network relay;

FIG. 7 schematically illustrates an example of a RM radio device to network relay;

FIG. 8 schematically illustrates a user plane stack for an L2 RL radio device, the RAN and/or a further radio device and an RM radio device embodying the devices of FIGS. 1A, 1B and 1C, respectively;

FIG. 9 schematically illustrates a control plane stack for an L2 RL radio device, the RAN and/or a further radio device and an RM radio device embodying the devices of FIGS. 1A, 1B and 1C, respectively;

FIG. 10 schematically illustrates a connection establishment for a relayed radio connection for an RL radio device, the RAN and/or a further radio device and an RM radio device embodying the devices of FIGS. 1A, 1B and 1C, respectively;

FIG. 11 schematically illustrates an example of a grant allocation from a RAN forwarded through a RL radio device to two RM radio devices embodying the devices of FIGS. 1B, 1A and 1C, respectively;

FIG. 12 schematically illustrates a further example of a grant allocation from a RAN forwarded through a RL radio device to two RM radio devices embodying the devices of FIGS. 1B, 1A and 1C, respectively;

FIG. 13A shows an example schematic block diagram of a RL radio device embodying the device of FIG. 1A;

FIG. 13B shows an example schematic block diagram of a network node embodying the device of FIG. 1B;

FIG. 13C shows an example schematic block diagram of a RL radio device embodying the device of FIG. 1C;

FIG. 14 schematically illustrates an example telecommunication network connected via an intermediate network to a host computer;

FIG. 15 shows a generalized block diagram of a host computer communicating via a base station or radio device functioning as a gateway with a user equipment over a partially wireless connection; and

FIGS. 16 and 17 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including 3GPP LTE (e.g., LTE-Advanced or a related radio access technique such as MulteFire), in a Wireless Local Area Network (WLAN) according to the standard family IEEE 802.11, for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

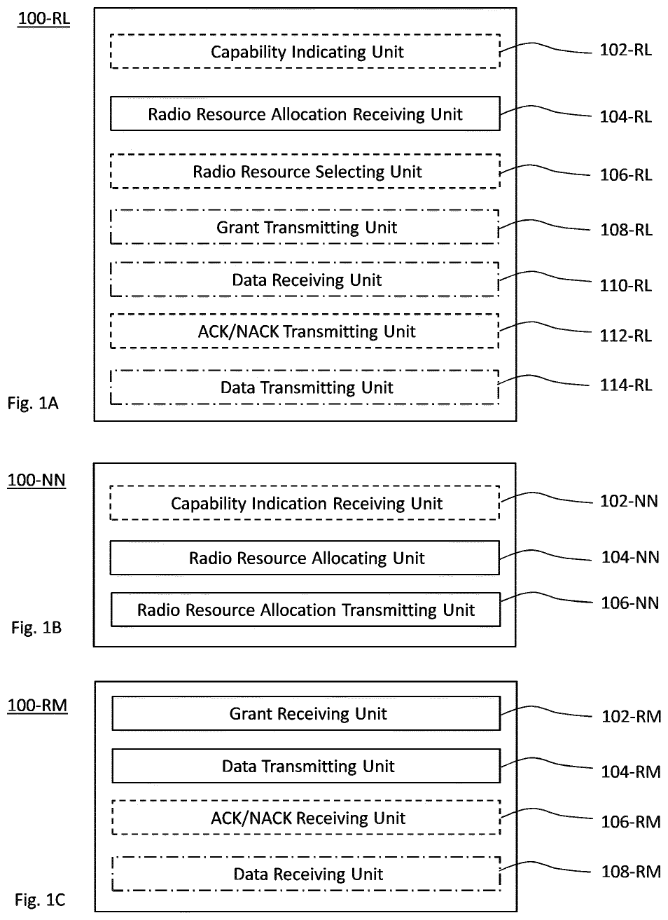

FIG. 1A schematically illustrates an example block diagram of a device for receiving a radio resource allocation at a relay (RL) radio device for at least one remote (RM) radio device in relayed radio communication with a RAN or a further radio device through the relay radio device. The first radio device is generically referred to by reference sign 100-RL.

The device 100-RL optionally comprises a capability indicating unit 102-RL that is configured to transmit, from the RL radio device 100-RL, a capability message indicative of the RL radio device 100-RL being capable of relaying the allocation of the radio resources to and/or of sharing the allocated radio resources with at least one RM radio device.

The device 100-RL comprises a radio resource allocation receiving unit 104-RL that is configured to receive, at the RL radio device 100-RL, a control message indicative of radio resources allocated to a device-to-device (D2D) communication between the at least one RM radio device and the RL radio device (100-RL).

The device 100-RL optionally further comprises a radio resource selecting unit 106-RL that is configured to select, from a plurality of allocated radio resources received in the control message, radio resources to be used for the D2D communication between the RL radio device 100-RL and the at least one RM radio device or one of the at least one RM radio device.

The device 100-RL optionally comprises a grant transmitting unit 108-RL that is configured to transmit, from the RL radio device 100-RL to the RM radio device, a grant for a data transmission from the RM radio device to the relay radio device 100-RL. The grant may be comprised in the radio resource allocation received at the relay radio device 100-RL.

The device 100-RL optionally further comprises a data receiving unit 110-RL that is configured to receive at the RL radio device 100-RL a data transmission on the allocated radio resources from the RM radio device to be relayed to the RAN or the further radio device.

The device 100-RL optionally still further comprises an ACK/NACK transmitting unit 112-RL that is configured to transmit, from the RL radio device 100-RL to the RM radio device, an acknowledgement (ACK) and/or a negative acknowledgement (NACK) indicative of the reception of the data transmission and/or indicative of the relaying of the data transmission to the RAN or to the further radio device.

The device 100-RL optionally comprises a data transmitting unit 114-RL that is configured to perform a data transmission from the RL radio device 100-RL to the RM radio device on the allocated radio resources.

Any of the units of the receiving device 100-RL may be implemented by modules configured to provide the corresponding functionality.

The device 100-RL may also be referred to as, or may be embodied by, a RL radio device. The device 100-RL and the RAN (e.g. a network node of the RAN) or the further radio device are in a radio communication at least for the reception of the radio resource allocation at the device 100-RL. Alternatively or in addition the device 100-RL and the RM radio device are in a radio communication at least for the transmission of a grant and/or of data at the device 100-RL.

FIG. 1B schematically illustrates an example block diagram of a device for transmitting a radio resource allocation to a RL radio device for at least one RM radio device in relayed radio communication with a RAN or a further radio device through the RL radio device. The device is generically referred to by reference sign 100-NN.

The device 100-NN optionally comprises a capability indication receiving unit 102-NN that is configured to receive, from the RL radio device, a capability message indicative of the RL radio device being capable of relaying an allocation of radio resources and/or being capable of sharing allocated radio resources.

The device 100-NN comprises a radio resource allocation unit 104-NN that is configured to allocate radio resources to a D2D communication between the at least one RM radio device and the RL radio device.

The device 100-NN further comprises a radio resource allocation transmitting unit 106-NN that is configured to transmit, to the RL radio device, a control message indicative of the radio resources allocated to the D2D communication between the at least one RM radio device and the RL radio device.

Any of the units of the device 100-NN may be implemented by modules configured to provide the corresponding functionality.

The device 100-NN may also be referred to as, or may be embodied by, a network node of the RAN or a further radio device. The device 100-NN and the RL radio device are in a radio communication at least for the transmission of the allocation of radio resources.

FIG. 1C schematically illustrates an example block diagram of a device for receiving a radio resource allocation from a RL radio device at a RM radio device in relayed radio communication with a RAN or a further radio device through the relay radio device. The device is generically referred to by reference sign 100-RM.

The device 100-RM comprises a grant receiving unit 102-RM that is configured to receive, at the RM radio device 100-RM from the RL radio device, a grant for a data transmission from the RM radio device to the RL radio device in the relayed radio communication and/or to receive, at the RM radio device 100-RM from the RL radio device, a scheduling assignment for a data reception from the RL radio device at the RM radio device 100-RM in the relayed radio communication.

The device 100-RM further comprises a data transmitting unit 104-RM that is configured to transmit data, from the RM radio device 100-RM to the RL radio device, on the allocated radio resources for relaying to a RAN or to a further radio device.

The device 100-RM optionally further comprises an ACK/NACK receiving unit 106-RM that is configured to receive, from the RL radio device at the RM radio device 100-RM, an acknowledgement (ACK) and/or a negative acknowledgement (NACK) indicative of the reception of the data transmission and/or indicative of the relaying of the data transmission to the RAN or to the further radio device.

The device 100-RM optionally still further comprises a data receiving unit 108-RM that is configured to receive a data transmission, from the RL radio device at the RM radio device 100-RM, on a received radio resource allocation (e.g., according to the scheduling assignment).

Any of the units of the device 100-RM may be implemented by modules configured to provide the corresponding functionality.

The device 100-RM may also be referred to as, or may be embodied by, a RM radio device. The device 100-RM and a RL radio device are in a radio communication at least for the reception of the grant for a data transmission and/or the reception of a scheduling assignment for a data reception at the device 100-RM.

The technique may be applied to uplink (UL), downlink (DL) or direct communications between radio devices, e.g., device-to-device (D2D) communications or sidelink communications.

Each of the device 100-RL, the device 100-NN, and the device 100-RM may be a radio device and/or a network node (e.g., a base station). Herein, any radio device may be a mobile or portable station and/or any radio device wirelessly connectable to the network node (e.g., a base station) and/or the RAN, or to another radio device. A radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP sidelink connection. Furthermore, any base station may be a station providing radio access, may be part of a radio access network (RAN) and/or may be a node connected to the RAN for controlling radio access. Further a base station may be an access point, for example a Wi-Fi access point.

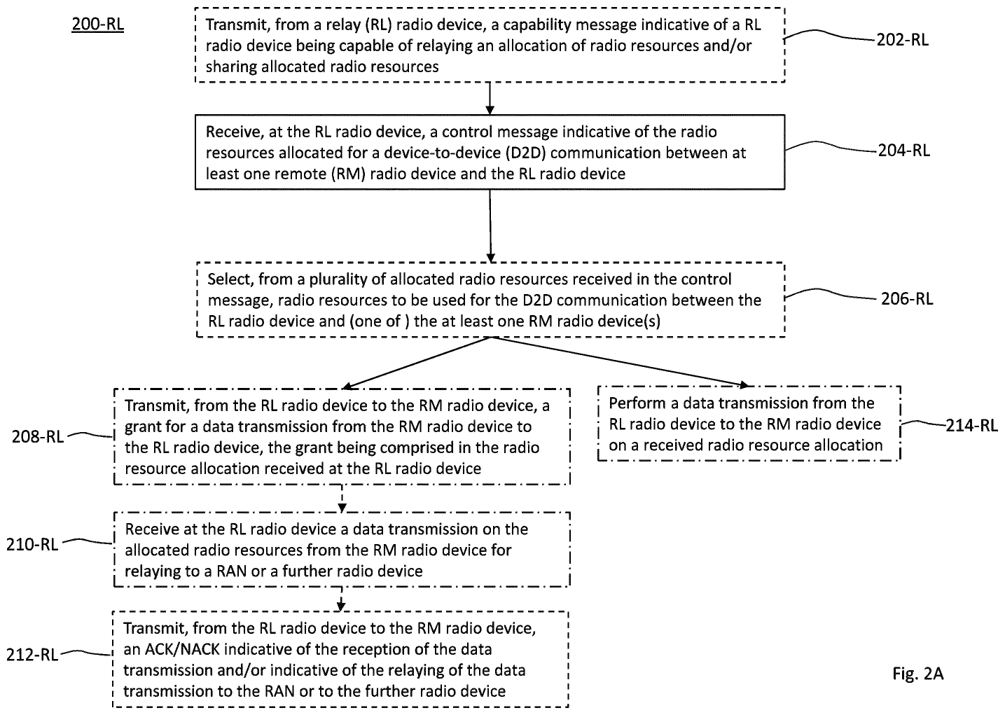

FIG. 2A shows an example flowchart for a method 200-RL according to the first method aspect in the list of embodiments.

The method 200-RL may be performed by the device 100-RL. For example, the units 102-RL, 104-RL, 106-RL, 108-RL, 110-RL, 112-RL and 114-RL may perform the steps, 202-RL, 204-RL, 206-RL, 208-RL, 210-RL, 212-RL and 214-RL respectively.

FIG. 2B shows an example flowchart for a method 200-NN according to the second method aspect in the list of embodiments.

The method 200-NN may be performed by the device 100-NN. For example, the units 102-NN, 104-NN and 106-NN may perform the steps 202-NN, 204-NN and 206-NN, respectively.

FIG. 2C shows an example flowchart for a method 200-RM according to the third method aspect in the list of embodiments.

The method 200-RM may be performed by the device 100-RM. For example, the units 102-RM, 104-RM and 106-RM may perform the steps 202-RM, 204-RM and 206-RM, respectively.

As to a first method aspect, a method of receiving a radio resource allocation at a relay radio device for at least one remote radio device in relayed radio communication with a radio access network (RAN) or a further radio device through the relay radio device is provided. The method comprises or initiate a step of receiving, at the relay radio device, a control message indicative of radio resources allocated to a device-to-device (D2D) communication between the at least one remote radio device and the relay radio device.

By receiving the control message indicative of the allocated radio resources (i.e., the allocation of radio resources) for the D2D communication (e.g., the sidelink) between the RL radio device and the RM radio device, e.g., from the RAN (e.g., from a network node of the RAN) or the further radio device according to an embodiment of the method, radio resources may be allocated flexibly to the relayed radio connection. Same or further embodiments can improve a radio resource utilization efficiency. Same or still further embodiments can avoid or reduce collisions of messages and/or signals pertaining to relayed radio communications of at least two RM radio devices in D2D (e.g., SL) communication with the RL radio device. Alternatively or in addition, a congestion of the relayed radio communication can be avoided.

Each of the at least one remote radio device may be in a relayed radio communication between the respective one of the at least one remote radio device and the RAN (e.g., a network node or base station of the RAN) or the further radio device through the relay radio device.

The D2D communication may also be referred to as a D2D link or D2D wireless connection.

The radio resource allocation for the at least one remote radio device may refer to the radio resources allocated to the at least one remote radio device or one of the at least one remote radio device or to the D2D communication in which the at least one remote radio device or one of the at least one remote radio device is involved. The radio resource allocation may also be referred to as the allocation of the radio resources.

Herein, the expression radio resource allocation (or briefly: allocation) and the expression control message (or briefly: message) indicative of the allocated radio resources may be interchangeable.

The relayed radio communication between the (e.g., at least one) remote radio device and the RAN (e.g., a network node or base station of the RAN) or the further radio device may involve the relay radio device and, optionally, one or more further relay radio devices. Each of the relay radio device and the one or more further relay radio devices may function as a relay radio device in a chain of D2D communications.

The D2D communication and the chain of D2D communications between the (e.g., at least one) remote radio device and the RAN or the further radio device may also be referred to as a single hop and multiple hops, respectively. The D2D communication or each of the multiple D2D communications may be a segment or a leg of the relayed radio communication.

The further radio device may be a further remote radio device.

The D2D communication (e.g., according to the first method aspect) may use a sidelink between the relay radio device and the at least one remote radio device.

The sidelink (SL) may be a segment or a leg of the relayed radio communication. The D2D communication may use a radio communication protocol according to 3GPP NR or 3GPP LTE. The D2D communication may use a SL between the relay radio device and each of the at least one remote radio device.

The D2D communication (e.g., according to the first method aspect) may use a peer-to-peer radio connection between the relay radio device and the at least one remote radio device.

The peer-to-peer connection may be a segment or a leg of the relayed radio communication. The D2D communication may use a radio communication protocol according to Wi-Fi Direct (also referred to as Wi-Fi Peer-to-Peer), e.g., according to the Wi-Fi Alliance.

The control message (e.g., according to the first method aspect) may be indicative of the at least one remote radio device or one of the at least one remote radio device to which the radio resources are allocated.

The radio resource allocation and/or the control message may comprise a dynamic scheduling, e.g., a dynamic grant, for the at least one remote radio device. Alternatively or in addition, the radio resource allocation and/or the control message may comprise a configured grant for the at least one remote radio device.

The radio resource allocation and/or the control message may comprise a scheduling assignment for a sidelink (SL) transmission from the relay (RL) radio device to the remote (RM) radio device. Alternatively or in addition, the radio resource allocation and/or the control message may comprise a grant for a SL transmission from the RM radio device to the RL radio device. Further alternatively or in addition, the radio resource allocation may comprise a scheduling assignment and/or a grant for a further radio communication technology (also referred to as a further radio access technology, RAT). The further RAT may comprise Wi-Fi or Bluetooth.

The radio resource allocation and/or the control message may be received from a network node of a radio communication system, e.g., from a base station of the RAN. Alternatively or in addition, the relay radio device may be or may comprise a radio device within a coverage range (e.g., within a cell) of the network node. Further alternatively or in addition, the remote radio device may be or may comprise a radio device out of the coverage range (e.g., out of the cell) of the network node and/or within a coverage range of the relay radio device.

Any radio device herein may also be denoted as a user equipment. For example, the RL radio device may also be denoted as RL user equipment (RL-UE) and/or the at least one RM radio device may also be denoted as RM-UE. Alternatively or in addition, the network node may comprise a gNodeB (gNB) according to the 3GPP New Radio (NR).

The method may be applicable to Layer 2 (L2) relay. For example, the RL radio device may be configured to relay the relayed radio communication on L2 of a protocol stack (e.g., of the RL radio device). The D2D communication may be terminated at the L2 of the protocol stack (e.g., at the RL radio device and/or the RM radio device). Alternatively or in addition, the method may be applicable to Layer 3 (L3) relay. For example, the relay radio device may be configured to relay the relayed radio communication on L3 of a protocol stack (e.g., of the RL radio device). The D2D communication may be terminated at the L3 of the protocol stack (e.g., at the RL radio device and/or the RM radio device).

The RAN (e.g., according to the first or second or third method aspect) may comprise a network node in radio communication with the relay radio device.

The network node may be or may comprise a base station and/or a cell of the RAN. The network node may serve the RL radio device. The radio communication may be or may comprise a further segment or leg of the relayed radio communication.

The control message (e.g., according to the first or second or third method aspect) may be or comprise a downlink control information (DCI).

The DCI may be indicative of the at least one RM radio device or one of the at least one RM radio device.

The control message (e.g., according to the first or second or third method aspect) may comprise a bit field of at least one bit indicative of the at least one remote radio device.

For each of the at least one RM radio device, the bit field may comprise one or more bits that is or are indicative of whether or not of the radio resources are allocated or allocatable to the respective one of the at least one RM radio device.

For each of the at least one RM radio device, the control message, e.g., the bit field, may be indicative of the radio resources (e.g., in the time domain and/or the frequency domain) allocated to the respective one of the at least one RM radio device.

The bit field may be a bitmap field.

The control message (e.g., according to the first or second or third method aspect) may be indicative of the at least one remote radio device or one of the at least one remote radio device to which the radio resources are allocated by at least one of a time domain and/or a frequency domain in which the control message is transmitted; a demodulation reference signal (DM-RS) sequence; a search space of a physical channel on which the control message is transmitted, preferably a search space of the physical downlink control chancel (PDCCH); and a radio network temporary identifier (RNTI) to which the control message is addressed.

The control message (e.g., according to the first or second or third method aspect) may comprise at least one of radio resource control (RRC) signaling and a medium access control (MAC) control element (CE).

The radio resource allocation may be received by means of RRC signaling and/or a MAC CE.

The radio resources may be configured (e.g., as a configured grant), e.g., by means of RRC signaling. The configured radio resources may be activated or deactivated by the control message, e.g., by a DCI (e.g., according to a Type 2 configured grant) or a MAC CE or RRC signaling (e.g., according to a Type 1 configured grant).

The method (e.g., according to the first method aspect) may further comprises or initiate the step of selecting, from a plurality of allocated radio resources received in the control message, radio resources to be used for the D2D communication between the relay radio device and the at least one remote radio device or one of the at least one remote radio device.

The method may comprise selecting, from a plurality of configurations of the radio resources received in the control message, a configuration to be used for the relayed radio communication between the relay radio device and the remote radio device.

The method (e.g., according to the first method aspect) may further comprises or initiate a step of transmitting, from the relay radio device to the remote radio device, a grant for a data transmission from the remote radio device to the relay radio device. The grant may be comprised in the radio resource allocation received at the relay radio device.

The grant (e.g., according to the first method aspect) may be transmitted by at least one of RRC signaling; a MAC-CE; and Layer 1 (L1) signaling.

The L1 signaling may comprise SL control information (SCI) signaling.

The method (e.g., according to the first method aspect) may further comprise or initiate a step of receiving at the relay radio device a data transmission on the allocated radio resources from the remote radio device to be relayed to the RAN or the further radio device.

The method (e.g., according to the first method aspect) may further comprise or initiate a step of transmitting, from the relay radio device to the remote radio device, an acknowledgement indicative of at least one of the reception of the data transmission and the relaying of the data transmission to the RAN or the further radio device.

The method (e.g., according to the first method aspect) may further comprise or initiate the step of performing a data transmission from the relay radio device to the remote radio device on the allocated radio resources.

The at least one remote radio device (e.g., according to the first or second or third method aspect) may comprise at least two remote radio devices. The control message indicative of the radio resources may comprise the radio resource allocations for both or each of the at least two remote radio devices.

The allocated radio resources (e.g., according to the first or second or third method aspect) may be shared between the relay radio device and the remote radio device.

Sharing radio resources may comprise transmitting data and receiving data on the shared radio resources. The radio resource allocation may be shared between the relay radio device and the remote radio device.

Sharing the allocated radio resources between the relay radio device and the remote radio device may comprise selecting (optionally by the relay radio device) disjoint subsets of the allocated radio resources for the relay radio device and the remote radio device, respectively. The relay radio device may transmit, to the at least one remote radio devices, a further control message (e.g., an SCI) indicative of the respective subset of the allocated radio resources.

The at least one remote radio device (e.g., according to the first or second or third method aspect) may comprise at least two remote radio devices. The allocated radio resources may be shared between the at least two remote radio devices.

Sharing radio resources may comprise transmitting data and receiving data on the shared radio resources. The radio resource allocation may be shared between the at least two remote radio devices.

Sharing the allocated radio resources between the at least two remote radio devices may comprise selecting (optionally by the relay radio device) disjoint subsets of the allocated radio resources for the at least two remote radio devices, respectively. The relay radio device may transmit, to each of the at least two remote radio devices, a further control message (e.g., an SCI) indicative of the respective subset of the allocated radio resources.

The control message indicative of the allocated radio resource is further indicative of at least one the radio resource. The radio resource may be allocated for at least one of a predetermined time period; a predetermined number of transmission occasions; and a predefined number of data packets.

The allocated radio resource may be the shared radio resources.

The control message (e.g., according to the first or second or third method aspect) indicative of the allocated radio resource may be further indicative of an allocation of the radio resources for control signaling and/or data packets.

A data packet may comprise a protocol data unit (PDU), e.g., received from a packet data convergence protocol (PDCP).

The allocation of radio resources for control signaling and/or data packets may comprise an allocation of transmission occasions. Alternatively or in addition, a transmission occasion may be flexible. The flexibility may relate to allocating control signaling and/or data packets. Alternatively or in addition, the flexibility may relate to the direction of the D2D communication between the relay radio device and the remote radio device.

The method (e.g., according to the first method aspect) may further comprise or initiate the step of transmitting, from the relay radio device, a capability message indicative of the relay radio device being capable of at least one of relaying the allocation of the radio resources and sharing the allocated radio resources.

The indication of the relay radio device being cable of sharing a radio resource allocation may be transmitted to the RAN or the further radio device.

The capability of relaying (relaying capability) of the relay radio device may comprise relaying the allocation of the radio resources, e.g., relaying the control message, which is indicative of the allocated radio resources, to the at least one remote radio device and/or transmitting a grant or a scheduling assignment for the allocated radio resources to the at least one remote radio device and/or transmitting a grant or a scheduling assignment for the subset of the allocated radio resources to the at least one remote radio device.

The method (e.g., according to the first method aspect) may further comprise or initiate the step of receiving, from the remote radio device, a scheduling request for the relayed radio communication.

The method (e.g., according to the first method aspect) may further comprise or initiate the step of responsive to the scheduling request received from the remote radio device, transmitting a scheduling grant for the allocated radio resources or a subset of the allocated radio resources to the at least one remote radio device or forwarding the scheduling request to the RAN or the further radio device.

The control message (e.g., according to the first or second or third method aspect) may be addressed to the relay radio device and indicative of the at least one remote radio device or one of the at least one remote radio device to which the radio resources are allocated.

The control message (e.g., a DCI) may be addressed to the RL radio device by a RNTI of the RL radio device.

The control message (e.g., according to the first or second or third method aspect) may be addressed to the at least one remote radio device. Receiving the control message may comprise decoding the control message using a RNTI of the at least one remote radio device.

The control message (e.g., a DCI) may be addressed to the RM radio device by a RNTI of the RM radio device.

As to a second method aspect, a method of transmitting a radio resource allocation to a relay radio device for at least one remote radio device in relayed radio communication with a radio access network (RAN) or a further radio device through the relay radio device is provided. The method comprises or initiates the steps of allocating radio resources to a device-to-device (D2D) communication between the at least one remote radio device and the relay radio device; and transmitting, to the relay radio device, a control message indicative of the radio resources allocated to the D2D communication between the at least one remote radio device and the relay radio device.

The method (e.g., according to the second method aspect) may further comprise or initiate any of the steps and/or features of the first method aspect or steps and/or features corresponding thereto.

As to a third method aspect, a method of receiving a radio resource allocation from a relay radio device at a remote radio device in relayed radio communication with a radio access network (RAN) or a further radio device through the relay radio device is provided. The method comprises or initiates the step of receiving, at the remote radio device from the relay radio device, at least one of a grant for a data transmission from the remote radio device to the relay radio device in the relayed radio communication and a scheduling assignment for a data reception from the relay radio device at the remote radio device in the relayed radio communication.

The method (e.g., according to the third method aspect) may further comprise or initiate any of the steps and/or features of the first or second method aspect or steps and/or features corresponding thereto.

As to another aspect, a computer program product comprising program code portions for performing the steps of any one of the first and/or the second and/or third method aspect when the computer program product is executed on one or more computing devices, optionally stored on a computer-readable recording medium.

As to a first device aspect, a device for receiving a radio resource allocation at a relay radio device for at least one remote radio device in relayed radio communication with a radio access network (RAN) or a further radio device through the relay radio device is provided. The device is configured to receive, at the relay radio device, a control message indicative of radio resources allocated to a device-to-device (D2D) communication between the at least one remote radio device and the relay radio device.

The device (e.g., according to the first device aspect) may further be configured to perform the steps of any one of the first method aspect.

As to a second device aspect, a device for transmitting a radio resource allocation to a relay radio device for at least one remote radio device in relayed radio communication with a radio access network (RAN) or a further radio device through the relay radio device is provided. The device may be configured to allocate radio resources to a device-to-device (D2D) communication between the at least one remote radio device and the relay radio device; and transmit, to the relay radio device, a control message indicative of the radio resources allocated to the D2D communication between the at least one remote radio device and the relay radio device.

The device (e.g., according to the second device aspect) may further be configured to perform the steps of any one of the second method aspect.

As to a third device aspect a device for receiving a radio resource allocation from a relay radio device at a remote radio device in relayed radio communication with a radio access network (RAN) or a further radio device through the relay radio device is provided. The device configured to receive, at the remote radio device from the relay radio device, at least one of a grant for a data transmission from the remote radio device to the relay radio device in the relayed radio communication and a scheduling assignment for a data reception from the relay radio device at the remote radio device in the relayed radio communication.

The device (e.g., according to the third device aspect) may further be configured to perform the steps of any one of the third method aspect.

The device according to the first and/or second device aspect may be a base station. The base station may be configured to communicate with a user equipment (UE). The base station may comprise a radio interface and processing circuitry configured to execute the steps of any one of the first and/or second method aspects.

Alternatively or in addition, the device according to the first, second and/or third device aspect may be a user equipment (UE). The UE may be configured to communicate with a base station or radio device functioning as a gateway. The UE may comprise a radio interface and processing circuitry configured to execute the steps of any one of the first and/or second and/or third method aspects.

As the still further device aspect, a communication system including a host computer is provided. The host computer comprises processing circuitry configured to provide user data; and a communication interface configured to forward user data to a cellular or ad hoc radio network for transmission to a user equipment (UE). The UE comprises a radio interface and processing circuitry. The processing circuitry of the UE is configured to execute the steps of any one of the steps of the first and/or second and/or third method aspect.

The communication system (e.g., according to the still further device aspect) may further include the UE.

The communication system (e.g., according to the still further device aspect) may be the radio network. The radio network may further comprise a base station or radio device functioning as a gateway configured to communicate with the UE.

The processing circuitry of the host computer (e.g., according to the still further device aspect) may be configured to execute a host application, thereby providing the user data; and the processing circuitry of the UE is configured to execute a client application associated with the host application.

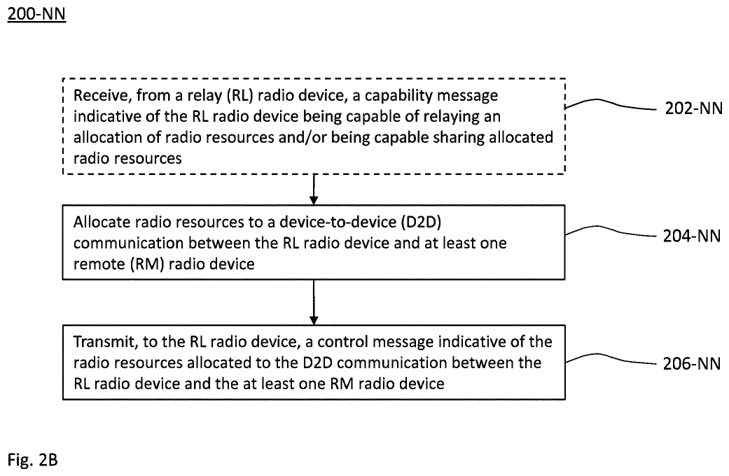

FIG. 3 shows an example deployment scenario for a relayed radio communication 300. The deployment scenario comprises a network node 100-NN of a RAN with coverage area 302. A RL radio device 100-RL is in the coverage area 302 of the network node 100-NN. ARM radio device 100-RM is outside of the coverage area 302 of the network node 100-NN, but in proximity to the RL radio deice 100-RL. By being in the proximity, the RM radio device 100-RM and the RL radio device 100-RL may be in a D2D communication.

Any embodiment may be implemented using a frame structure for the relayed radio communication and/or the D2D communication, e.g., according to 3GPP NR.

Similar to LTE, NR uses OFDM (Orthogonal Frequency Division Multiplexing) in the DL (e.g., from a network node, gNB, eNB, or base station, to a user equipment or UE).

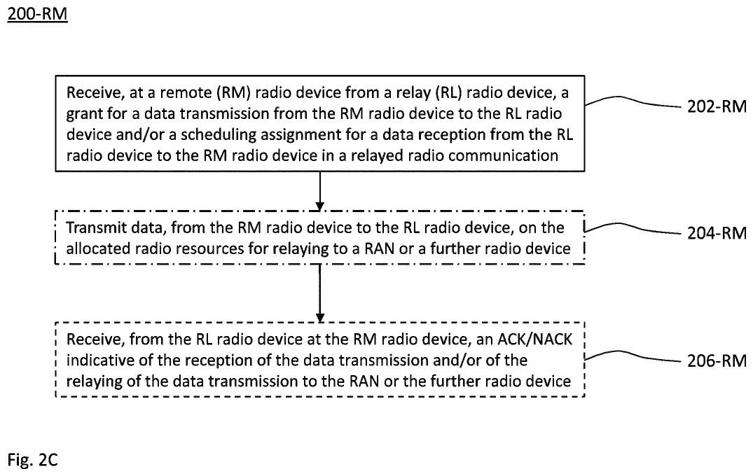

FIG. 4 schematically illustrates a physical resource grid 400 for a 3GPP NR implementation of the technique.

The basic NR physical resource over an antenna port can be seen as a time-frequency grid as illustrated in FIG. 4, where a resource block (RB) 402 in a 14-symbol slot 408 is shown. A RB 402 corresponds to 12 contiguous subcarriers 404 in the frequency domain. RBs 402 are numbered in the frequency domain, starting with 0 from one end of the system bandwidth. Each resource element (RE) 406 corresponds to one OFDM subcarrier during one OFDM symbol 410 interval. A slot 408 comprises 14 OFDM symbols 410.

Different subcarrier spacing values are supported in NR. The supported subcarrier spacing values (also referred to as different numerologies) are given by Δf=(15×2\hat{ }μ) kHz where μ∈(0, 1, 2, 3, 4). Δf=15 kHz is the basic (or reference) subcarrier spacing that is also used in LTE.

In the time domain, DL and UL transmissions in NR are organized into equally-sized subframes of 1 ms each similar to LTE. A subframe is further divided into multiple slots 408 of equal duration. The slot length for subcarrier spacing Δf=(15×2\hat{ }μ) kHz is (½)\hat{ }μ ms. There is only one slot 408 per subframe for Δf=15 kHz, and a slot 408 consists of 14 OFDM symbols 410.

DL transmissions are dynamically scheduled, e.g., in each slot the gNB transmits DL control information (DCI) about which radio device (e.g., UE) data is to be transmitted to and which RBs in the current DL slot the data is transmitted on. This control information is conventionally transmitted in the first one or two OFDM symbols in each slot in NR. The control information is carried on the Physical Control Channel (PDCCH), and data is carried on the Physical Downlink Shared Channel (PDSCH). A radio device (e.g., a UE) first detects and decodes PDCCH and, if a PDCCH is decoded successfully, it (e.g., the UE) then decodes the corresponding PDSCH based on the DL assignment provided by decoded control information in the PDCCH.

In addition to PDCCH and PDSCH, there are also other channels and reference signals transmitted in the downlink, including synchronization signal blocks (SSBs), channel state information reference signals (CSI-RS), etc.

UL data transmissions, carried on Physical Uplink Shared Channel (PUSCH), can also be dynamically scheduled by the gNB by transmitting a DCI. The DCI (which is transmitted in the DL region) indicates a scheduling time offset so that the PUSCH is transmitted in a slot in the UL region.

Any embodiment may be implemented using a sidelink (SL) in NR for the D2D communication.

SL transmissions over New Radio (NR) are specified for Release 16. These are enhancements of the PROximity-based Services (ProSe) specified for Long Term Evolution (LTE). Four new enhancements are particularly introduced to NR sidelink transmissions as follows:
Support for unicast and groupcast transmissions are added in NR SL. For unicast and groupcast, the physical sidelink feedback channel (PSFCH) is introduced for a receiver radio device (e.g., a receiver UE) to reply the decoding status to a transmitter radio device (e.g., a transmitter UE).
Grant-free transmissions, which are adopted in NR UL transmissions, are also provided in NR SL transmissions, to improve the latency performance.
To alleviate resource collisions among different SL transmissions launched by different radio devices (e.g., different UEs), it enhances channel sensing and resource selection procedures, which also lead to a new design of PSCCH.
To achieve a high connection density, congestion control and thus the quality of service (QoS) management is supported in NR SL transmissions.

To enable the above enhancements, new physical channels and reference signals (RSs) are introduced in NR (e.g., available in LTE before):
PSSCH (Physical Sidelink Shared Channel, SL version of PDSCH): The PSSCH is transmitted by a SL transmitter radio device (e.g., SL transmitter UE), which conveys SL transmission data, system information blocks (SIBs) for radio resource control (RRC) configuration, and a part of the sidelink control information (SCI).
PSFCH (Physical Sidelink, SL version of PUCCH): The PSFCH is transmitted by a SL receiver radio device (e.g., a SL receiver UE) for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver radio device (e.g., a receiver UE) arrives at a transmitter radio device (e.g., a transmitter UE), a transmitter radio device (e.g., transmitter UE) should first send the PSCCH, which conveys a part of SCI (Sidelink Control information, SL version of DCI) to be decoded by any radio device (e.g., UE) for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar DL transmissions in NR, in SL transmissions, primary and secondary synchronization signals (called S-PSS and S-SSS, respectively) are supported. Through detecting the S-PSS and S-SSS, a radio device (e.g., a UE) is able to identify the SL synchronization identity (SSID) from the radio device (e.g., UE) sending the S-PSS/S-SSS. Through detecting the S-PSS/S-SSS, a radio device (e.g., UE) is therefore able to know the characteristics of the radio device (e.g., UE) transmitting the S-PSS/S-SSS. A series of processes of acquiring timing and frequency synchronization together with SSIDs of radio devices (e.g., UEs) is called initial cell search. Note that the radio device (e.g., UE) sending the 5-PSS/S-SSS may not be necessarily involved in SL transmissions, and a node (e.g., a UE and/or eNB and/or gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSI-RS): These physical reference signals supported by NR DL/UL transmissions are also adopted by SL transmissions. Similarly, the PT-RS is only applicable for FR2 transmission.

Another feature (e.g., of Release 16) is the two-stage SL control information (SCI). This a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and can be read by all radio devices (e.g., UEs) while the remaining (second stage) scheduling and control information such as a 8-bits source identity (ID) and a 16-bits destination ID, NDI, RV and HARQ process ID is sent on the PSSCH to be decoded by the receiver radio device (e.g., UE).

Similar as for PRoSE in LTE, SL transmissions according to NR have the following two modes of resource allocations:
Mode 1: SL resources are scheduled by a network node (e.g., gNB).
Mode 2: The radio device (e.g., UE) autonomously selects SL resources from a configured or preconfigured SL resource pool(s) based on the channel sensing mechanism.

For the in-coverage radio device (e.g., UE), a network node (e.g., gNB) can be configured to adopt Mode 1 or Mode 2. For the out-of-coverage radio device (e.g., UE), only Mode 2 can be adopted.

As in LTE, scheduling over the SL in NR is done in different ways for Mode 1 and Mode 2.

Mode 1 supports the following two kinds of grants, namely dynamic grants and configured grants.

Dynamic grant: When the traffic to be sent over SL arrives at a transmitter radio device (e.g., UE), this radio device (e.g., UE) should launch the four-message exchange procedure to request SL resources from a network node, e.g. gNB (SR on UL, grant, BSR on UL, grant for data on SL sent to the radio device, e.g., UE). During the resource request procedure, a network node (e.g., gNB) may allocate a SL radio network temporary identifier (SL-RNTI) to the transmitter radio device (e.g., UE). If this SL resource request is granted by a network node (e.g., gNB), then a network node (e.g., gNB) indicates the resource allocation for the PSCCH and the PSSCH in the downlink control information (DCI) conveyed by PDCCH with cyclic redundancy check (CRC) scrambled with the SL-RNTI. When a transmitter radio device (e.g., UE) receives such a DCI, a transmitter radio device (e.g., UE) can obtain the grant only if the scrambled CRC of DCI can be successfully solved by the assigned SL-RNTI. A transmitter radio device (e.g., UE) then indicates the time-frequency resources and the transmission scheme of the allocated PSSCH in the PSCCH, and launches the PSCCH and the PSSCH on the allocated resources for SL transmissions. When a grant is obtained from a network node (e.g., gNB), a transmitter radio device (e.g., UE) can only transmit a single transport block (TB). As a result, this kind of grant is suitable for traffic with a loose latency requirement.

Configured grant: For the traffic with a strict latency requirement, performing the four-message exchange procedure to request SL resources may induce unacceptable latency. In this case, prior to the traffic arrival, a transmitter radio device (e.g., UE) may perform the four-message exchange procedure and request a set of resources. If a grant can be obtained from a network node (e.g., gNB), then the requested resources are reserved in a periodic manner. Upon traffic arriving at a transmitter radio device (e.g., UE), this radio device (e.g., UE) can launch the PSCCH and the PSSCH on the upcoming resource occasion. This kind of grant is also known as grant-free transmissions.

In both dynamic grant and configured grant, a SL receiver radio device (e.g., UE) cannot receive the DCI since it is addressed to the transmitter radio device (e.g., UE), and therefore a receiver radio device (e.g., UE) should perform blind decoding to identify the presence of PSCCH and find the resources for the PSSCH through the SCI.

When a transmitter radio device (e.g., UE) launches the PSCCH, CRC is also inserted in the SCI without any scrambling.

In the Mode 2 resource allocation, when traffic arrives at a transmitter radio device (e.g., UE), this transmitter radio device (e.g., UE) should autonomously select resources for the PSCCH and the PSSCH. To further minimize the latency of the feedback HARQ ACK/NACK transmissions and subsequently retransmissions, a transmitter radio device (e.g., UE) may also reserve resources for PSCCH/PSSCH for retransmissions. To further enhance the probability of successful TB decoding at one shot and thus suppress the probability to perform retransmissions, a transmitter radio device (e.g., UE) may repeat the TB transmission along with the initial TB transmission. This mechanism is also known as blind retransmission. As a result, when traffic arrives at a transmitter radio device (e.g., UE), then this transmitter radio device (e.g., UE) should select resources for the following transmissions:
1) The PSSCH associated with the PSCCH for initial transmission and blind retransmissions.
2) The PSSCH associated with the PSCCH for retransmissions.

Since each transmitter radio device (e.g., UE) in SL transmissions should autonomously select resources for above transmissions, how to prevent different transmitter radio devices (e.g., UEs) from selecting the same resources turns out to be a critical issue in Mode 2. A particular resource selection procedure is therefore imposed to Mode 2 based on channel sensing. The channel sensing algorithm involves measuring reference signal received power (RSRP) on different subchannels and requires knowledge of the different radio devices (e.g., UEs) power levels of DMRS on the PSSCH or the DMRS on the PSCCH depending on the configuration. This information is known only after receiver SCI launched by (all) other radio devices (e.g., UEs). The sensing and selection algorithm is rather complex.

The D2D communication may be based on or initiated by a discovery procedure.

There are D2D discovery procedures for detection of services and applications offered by other radio devices (e.g., UEs) in close proximity. This is part of LTE Release 12 and Release 13. The discovery procedure has two modes, mode A based on open announcements (broadcasts) and mode B, which is request/response. The discovery mechanism is controlled by the application layer (ProSe). The discovery message is sent on the Physical Sidelink Discovery Channel (PSDCH), which is not available in NR. Also, there is a specific resource pool for announcement and monitoring of discovery messages. The discovery procedure can be used to detect radio devices (e.g., UEs) supporting certain services or applications before initiating direct communication.

The relayed radio communication through the relay radio device, e.g. device 100-RL, may be implemented as a Layer 3 (L3) UE-to-Network relay.

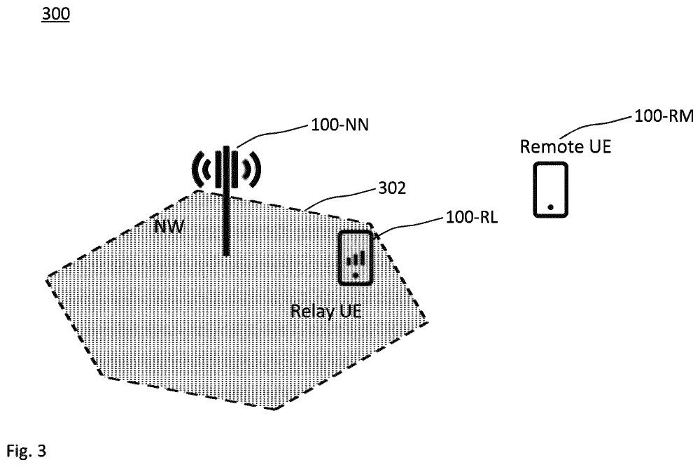

In the 3GPP document TR 23.752, version 0.3.0, clause 6.6, the layer-3 based UE-to-Network relay is described as further discussed in connection to FIG. 5.

As shown in FIG. 5, the ProSe 5G UE-to-Network Relay entity 100-RL provides the functionality to support connectivity to the network 100-NN, 508 for Remote UEs 100-RM. It can be used for both public safety services and commercial services (e.g. interactive service).

A UE is considered to be a Remote UE 100-RM for a certain ProSe UE-to-Network relay 100-RL if it has successfully established a PC5 link 502 to this ProSe 5G UE-to-Network Relay 100-RL. A Remote UE 100-RM can be located within NG-RAN 100-NN coverage or outside of NG-RAN c100-NN overage.

The ProSe 5G UE-to-Network Relay 100-RL shall relay unicast traffic (UL and DL) between the Remote UE 100-RM and the network 100-NN, 508, e.g. using the Uu interface 504. The ProSe UE-to-Network Relay 100-RL shall provide generic function that can relay any IP traffic.

The network may comprise an NG-RAN 100-NN, a 5G Core Network (5GC) 508 and an N6 link 506 to Access Stratum (AS) 510.

One-to-one Direct Communication is used between Remote UEs 100-RM and ProSe 5G UE-to-Network Relays 100-RL for unicast traffic as specified in solutions for Key Issue #2 in the 3GPP document TR 23.752, version 0.3.0.

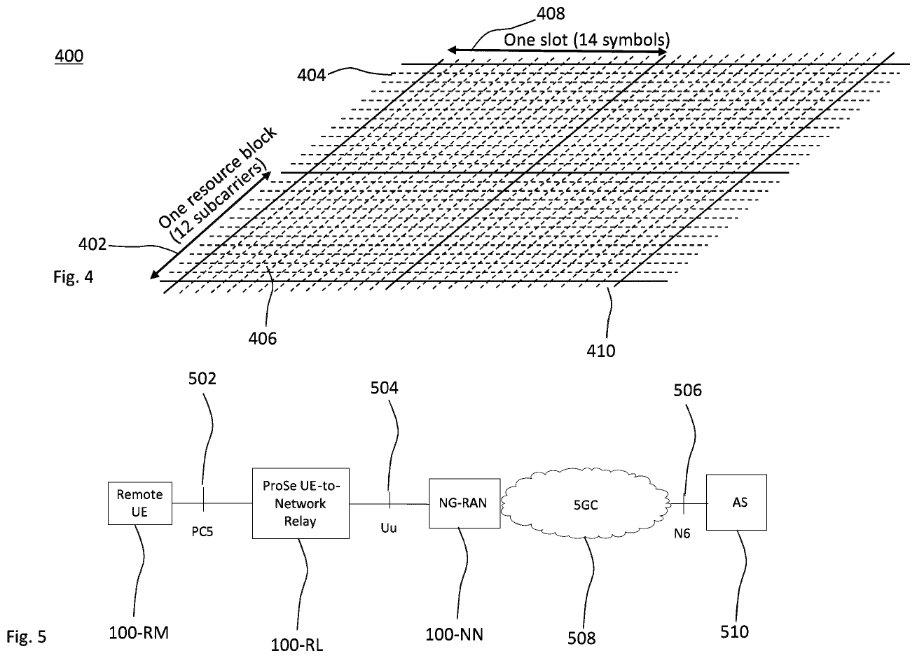

FIG. 6 schematically illustrates examples of protocol stacks for a L3 UE-to-Network Relay, e.g., according to ProSe 5G UE-to-Network Relay specified in the 3GPP document TR 23.752, version 0.3.0.

Hop-by-hop security is supported in the PC5 link 502 and Uu link 504. If there are requirements beyond hop-by-hop security for protection of RM radio device traffic, security over IP layer 602, 606, 612 needs to be applied.

Further security details (integrity and privacy protection for RM radio device to network communication) will be specified in SA WG3.

A ProSe 5G UE-to-Network Relay capable radio device (e.g., UE) 100-RL may register to the network (if not already registered) and establish a PDU session enabling the necessary relay traffic, or it may need to connect to additional PDU session(s) or modify the existing PDU session in order to provide relay traffic towards RM radio device(s) 100-RM (e.g., UE(s)). At least in some embodiments, PDU session(s) supporting UE-to-Network Relay shall only be used for Remote ProSe UE(s) relay traffic.

In FIG. 6, the network comprises a user plane function (UPF) at reference sign 614 with N3 link 610 to the network node 100-NN. The application layer 604 is an example of a transparent layer. Layers 606, 608 comprise an adaptation layer for the relayed radio communication.

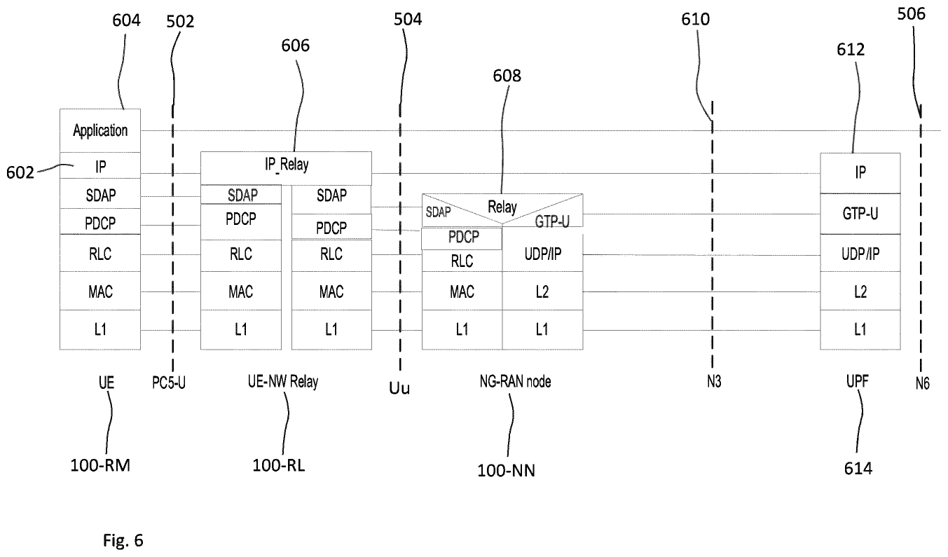

FIG. 7 schematically illustrates an example of a ProSe 5G UE-to-Network Relay according to the 3GPP document TR 23.752, version 0.3.0.

The RM radio device (e.g., UE) to network relayed radio communication in FIG. 7 comprises the following steps:
0. During the Registration procedure, Authorization and provisioning is performed at reference signs 706 and 708 for the RL radio device (e.g., ProSe UE-to-NW relay) 100-RL and the RM radio device (e.g., remote UE) 100-RM, respectively. Authorization and provisioning procedure may be any solution for key issue #1 and #3 in the 3GPP document TR 23.752, version 0.3.0.
1. The ProSe 5G UE-to-Network Relay may, at reference sign 710, establish a PDU session for relaying with default PDU session parameters received in step 0 (at reference signs 706, 708) or pre-configured in the RL radio device (e.g., UE-to-NW relay) 100-RL, e.g. S-NSSAI, DNN, SSC mode. In case of IPv6, the RL radio device (e.g., ProSe UE-to-Network Relay) 100-RL obtains the IPv6 prefix via prefix delegation function from the network as defined in TS 23.501 v16.5.0.
2. Based on the Authorization and provisioning in step 0 (at reference sign 706, 708), at reference sing 712 the RM radio device (e.g., Remote UE) 100-RM performs discovery of a RL radio device (e.g., ProSe 5G UE-to-Network Relay) 100-RL using any solution for key issue #1 and #3 in the 3GPP document TR 23.752, version 0.3.0. As part of the discovery procedure the RM radio device (e.g., Remote UE) 100-RM learns about the connectivity service the RL radio device (e.g., ProSe UE-to-Network Relay) 100-RL provides.
3. The RM radio device (e.g., Remote UE) 100-RM selects at reference sign 714 a RL radio device (e.g., ProSe 5G UE-to-Network Relay) 100-RL and establishes a connection for One-to-one ProSe Direct Communication as described in TS 23.287 v16.3.0 and/or modifies an existing communication as shown at reference sing 716.

If there is no PDU session satisfying the requirements of the PC5 connection with the RM radio device (e.g., remote UE) 100-RM, e.g. S-NSSAI, DNN, QoS, the RL radio device (e.g., ProSe 5G UE-to-Network Relay) 100-RL initiates a new PDU session establishment or modification procedure for relaying.
4. At reference sing 718, IPv6 prefix or IPv4 address is allocated for the RM radio device (e.g., remote UE) 100-RM as it is defined in TS 23.303 v16.0.0 clauses 5.4.4.2 and 5.4.4.3. From this point the uplink and downlink relaying can start.
5. The RL radio device (e.g., ProSe 5G UE-to-Network Relay) 100-RL sends a RM radio device (e.g., Remote UE) Report (e.g., comprising Remote User ID and/or IP info) message (e.g., through the access and mobility management function, AMF, 702) to the session management function (SMF) 704 for the PDU session associated with the relay. The Remote User ID is an identity of the RM radio device (e.g., Remote UE) user (provided via User Info) that was successfully connected in step 3 at reference signs 714, 716. The SMF 704 stores the Remote User IDs and the related IP info in the RL radio device (e.g., ProSe 5G UE-to-Network Relay) for the PDU connection associated with the relay.

For IP info the following principles apply:
for IPv4, the UE-to-network Relay (e.g., comprising legs 722, 724) shall report TCP/UDP port ranges assigned to individual RM radio devices (e.g., Remote UE(s)) 100-RM (along with the Remote User ID);
for IPv6, the UE-to-network Relay (e.g., comprising legs 722, 724) shall report IPv6 prefix(es) assigned to individual RM radio devices (e.g., Remote UE(s)) 100-RM (along with the Remote User ID).

The RM radio device (e.g., Remote UE) Report message at reference sign 720 shall be sent when the RM radio device (e.g., Remote UE) disconnects from the ProSe 5G UE-to-Network Relay (e.g. upon explicit layer-2 link release and/or based on the absence of keep alive messages over PC5) to inform the SMF 704 that the RM radio device(s) (e.g., Remote UE(s)) 100-RM has/have left.

In the case of Registration Update procedure involving SMF 704 change the Remote User ID(s) and/or related IP info corresponding to the connected RM radio device(s) (e.g., Remote UE(s)) are transferred to the new SMF 704 as part of SM context transfer for the relayed radio communication (e.g., ProSe 5G UE-to-Network Relay 100-RL).

It is noted that in order for the SMF 704 to have the RM radio device(s) (e.g., Remote UE(s)) 100-RM information, the Home Public Land Mobile Network (HPLMN) and the Visited PLMN (VPLMN), in which the RL radio device (e.g., ProSe 5G UE-to-Network Relay) 100-RL is authorized to operate, needs to support the transfer of parameters related to the RM radio device(s) (e.g., Remote UE(s)) 100-RM in case the SMF 704 is in the HPLMN.

It is further noted that when RM radio device(s) (e.g., Remote UE(s)) 100-RM disconnect from the RL radio device (e.g., ProSe UE-to-Network Relay) 100-RL, it is up to implementation how relaying PDU sessions are cleared and/or disconnected by the RL radio device (e.g., ProSe 5G UE-to-Network Relay) 100-RL.

After being connected to the RL radio device (e.g., ProSe 5G UE-to-Network Relay) 100-RL, the RM radio device (e.g., Remote UE) 100-RL keeps performing the measurement of the signal strength of the discovery message sent by the RL radio device (e.g., ProSe 5G UE-to-Network Relay 100-RL for relay reselection.

The technique may also work when the RM and/or RL radio device (e.g., ProSe 5G UE-to-Network Relay UE) 100-RM and/or 100-RL connects in EPS using LTE. In this case for the RM radio device (e.g., Remote UE) report the procedures defined in TS 23.303 v16.0.0 can be used.

The relayed radio communication through the RL radio device 100-RL may be implemented as a Layer 2 (L2) UE-to-Network relay.

In the 3GPP document TR 23.752, version 0.3.0, clause 6.7, the layer-2 based RL radio device (e.g., UE-to-Network relay 100-RL) is described.

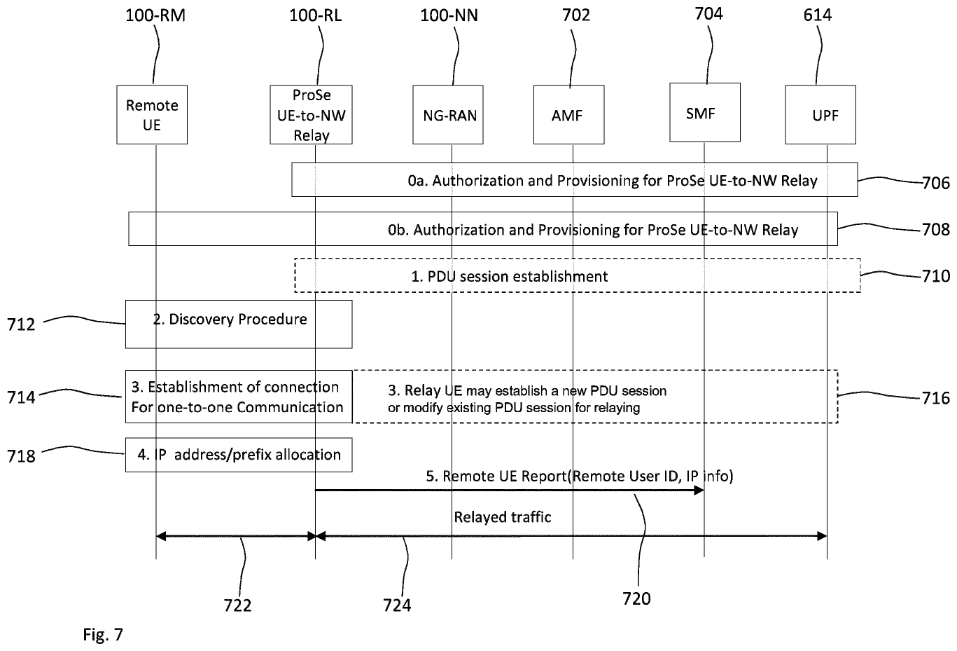

Hereinbelow, an example of the protocol architecture supporting a L2 RL radio device (e.g., UE-to-Network Relay UE) 100-RL is provided in connection with FIG. 8.

The L2 RL radio device (e.g., UE-to-Network Relay UE) 100-RL provides forwarding functionality that can relay any type of traffic over the PC5 link 502.

The L2 RL radio device (e.g., UE-to-Network Relay UE) 100-RL provides the functionality to support connectivity to the 5GS (e.g., NG-RAN 100-NN) for RM radio devices (e.g., Remote UEs) 100-RM. A radio device (e.g., UE) is considered to be a RM radio device (e.g., Remote UE) 100-RM if it has successfully established a PC5 link 502 to the L2 RL radio device (e.g., UE-to-Network Relay UE) 100-RL. A RM radio device (e.g., Remote UE) 100-RM can be located within NG-RAN 100-NN coverage or outside of NG-RAN 100-NN coverage.

FIG. 8 illustrates the protocol stack for the user plane transport according to the 3GPP document TR 23.752, version 0.3.0, related to a PDU session, including a Layer 2 RL radio device (e.g., UE-to-Network Relay UE) 100-RL. The PDU layer 802 corresponds to the PDU carried between the RM radio device (e.g., Remote UE) 100-RM and the Data Network (DN), e.g. represented by the UPF 614 in FIG. 8, over the PDU session. It is important to note that the two endpoints of the PDCP link are the RM radio device (e.g., Remote UE) and the network node (e.g., gNB) 100-NN. The relay function is performed below PDCP, e.g., a schematically depicted at reference sign 606. This means that data security is ensured between the RM radio device (e.g., Remote UE) 100-RM and the RAN and/or network node (e.g., gNB) 100-NN without exposing raw data at the RL radio device (e.g., UE-to-Network Relay UE) 100-RL.

The adaptation relay layer 606 within the RL radio device (e.g., UE-to-Network Relay UE) 100-RL can differentiate between signaling radio bearers (SRBs) and data radio bearers (DRBs) for a particular RM radio device (e.g., Remote UE) 100-RM. The adaption relay layer 606 is also responsible for mapping PC5 traffic (at reference sing 502) to one or more DRBs of the Uu interface at reference sing 504. The definition of the adaptation relay layer 606 is under the responsibility of RAN WG2.

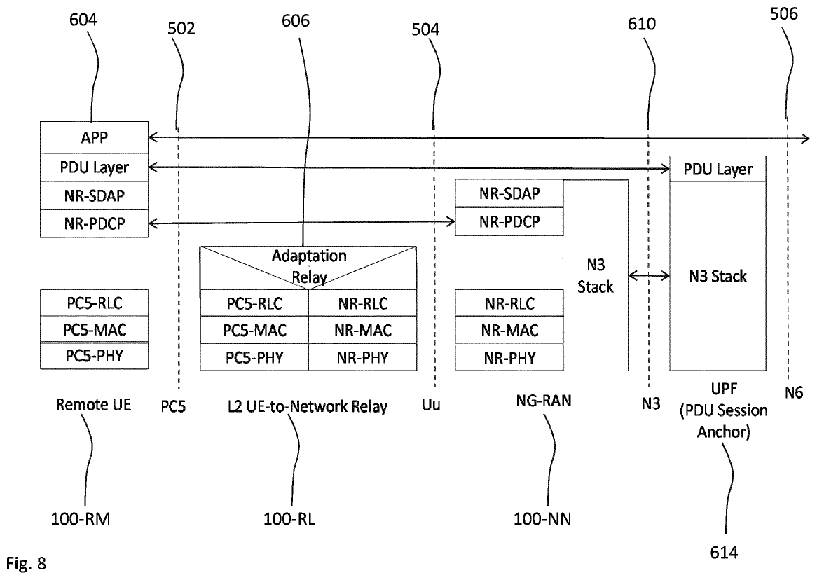

FIG. 9 illustrates the protocol stack of the non-access stratum (NAS) connection according to the 3GPP document TR 23.752 v0.3.0 for the RM radio device (e.g., Remote UE) 100-RM to the NAS-MM and NAS-SM components at reference sings 702 and 704, respectively. The NAS messages are transparently transferred between the RM radio device (e.g., Remote UE) 100-RM and 5G-RAN 100-NN over the Layer 2 RL radio device (e.g., UE-to-Network Relay UE) 100-RL using the following:
PDCP end-to-end connection where the role of the RL radio device (e.g., UE-to-Network Relay UE) 100-RL is to relay the PDUs over the signaling radio bear without any modifications.
N2 connection between the 5G-RAN 100-NN and AMF 702 over N2 at reference sign 902.
N3 connection between AMF 702 and SMF 704 over N11 at reference sign 904.

The role of the RL radio device (e.g., UE-to-Network Relay UE) 100-RL is to relay the PDUs from the signaling radio bearer without any modifications.

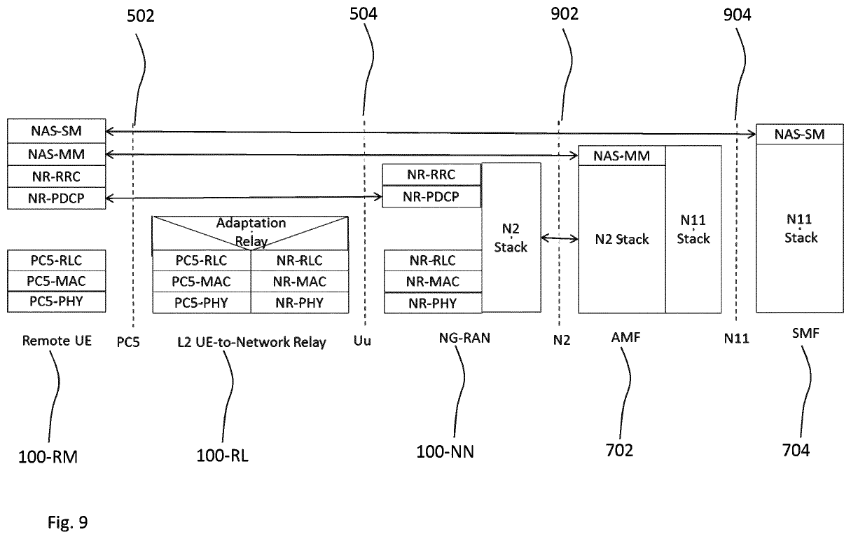

A connection establishment for the RM radio device 100-RM may comprise at least one of the steps in below described procedures in connection with FIG. 10, which schematically illustrates a connection establishment for a relayed (e.g., indirect) radio communication via a RL radio device (e.g., UE-to-Network Relay UE) 100-RL as described in the 3GPP document TR 23.752, version 0.3.0.

In a step 0, if in coverage, the RM radio device (e.g., Remote UE) 100-RM and RL radio device (e.g., UE-to-Network Relay UE) 100-RL may independently perform the initial registration to the network according to registration procedures in 3GPP document TS 23.502, version 16.5.0, at reference sign 1004. The allocated 5G global unique temporary identifier (GUTI) of the RM radio device (e.g., Remote UE) 100-RM is maintained when later NAS signaling between RM radio device (e.g., Remote UE) 100-RM and Network 100-NN is exchanged via the RL radio device (e.g., UE-to-Network Relay UE) 100-RL.

It is noted that the current procedures shown here assume a single hop relay. The technique disclosed herewith may be extended to multi-hop relay.

In a step 1 of the procedure at reference sign 1006, if in coverage, the RM radio device (e.g., Remote UE) 100-RM and RL radio device (e.g., UE-to-Network Relay UE) 100-RL independently get the service authorization for indirect communication from the network.

In steps 2-3, the RM radio device (e.g., Remote UE) 100-RM and RL radio device (e.g., UE-to-Network Relay UE) 100-RL perform RL radio device (e.g., UE-to-Network Relay UE) discovery and selection at reference sign 1008.

In step 4, the RM radio device (e.g., Remote UE) 100-RM initiates a one-to-one communication connection with the selected RL radio device (e.g., UE-to-Network Relay UE) 100-RL over PC5, by sending an indirect communication request message to the RL radio device (e.g., UE-to-Network Relay) 100-RL at reference sing 1010.

In step 5, if the RL radio device (e.g., UE-to-Network Relay UE) 100-RL is in CM_IDLE state, triggered by the communication request received from the RM radio device (e.g., Remote UE) 100-RM, the RL radio device (e.g., UE-to-Network Relay UE) 100-RL sends a Service Request message over PC5 to its serving AMF 702′ at reference sign 1012.

The Relay's AMF 702′ may perform authentication of the RL radio device (e.g., UE-to-Network Relay UE) 100-RL based on NAS message validation and, if needed, the AMF 702′ will check the subscription data.

If the RL radio device (e.g., UE-to-Network Relay UE) 100-RL is already in CM_CONNECTED state and is authorized to perform Relay service, the step 5 t reference sign 1012 is omitted.

In step 6, the RL radio device (e.g., UE-to-Network Relay UE) 100-RL sends the indirect communication response message to the RM radio device (e.g., Remote UE) 100-RM at reference sign 1014.

In step 7, the RM radio device (e.g., Remote UE) 100-RM sends a NAS message to the serving AMF 702″ at reference sign 1016. The NAS message is encapsulated in an RRC message that is sent over PC5 to the RL radio device (e.g., UE-to-Network Relay UE) 100-RL, and the RL radio device (e.g., UE-to-Network Relay UE) 100-RL forwards the message to the NG-RAN 100-NN. The NG-RAN 100-NN derives the RM radio device's (e.g., Remote UE's) serving AMF 702″ and forwards the NAS message to this AMF 702″.

It is noted that here it is assumed that the RM radio device's (e.g., Remote UE's) PLMN is accessible by the RL radio device (e.g., UE-to-Network Relay's) PLMN and that the RL radio device (e.g., UE-to-Network Relay UE) AMF 702′ supports all S-NSSAIs (e.g., network slice selection assistance information) the RM radio device (e.g., Remote UE) 100-RM may want to connect to.

If the RM radio device (e.g., Remote UE) 100-RM has not performed the initial registration to the network in step 0 at reference sign 1004, the NAS message is the initial registration message. Otherwise, the NAS message is a service request message.

If the RM radio device (e.g., Remote UE) 100-RM performs initial registration via the RL radio device (e.g., UE-to-Network relay) 100-RL, the RM radio device's (e.g., Remote UE's) 100-RM serving AMF 702″ may perform authentication of the RM radio device (e.g., Remote UE) 100-RM based on NAS message validation and, if needed, the RM radio device's (e.g., Remote UE's) AMF 702″ checks the subscription data.

For service request case, a User Plane connection for PDU Sessions can also be activated. The other steps follow the clause 4.2.3.2 in 3GPP document TS 23.502, version 16.5.0.

In step S, the RM radio device (e.g., Remote UE) 100-RM may trigger the PDU Session Establishment procedure as defined in clause 4.3.2.2 of 3GPP document TS 23.502, version 16.5.0, at reference sign 1018.

In step 9, the data is transmitted between RM radio device (e.g., Remote UE) 100-RM and UPF 614 via RL radio device (e.g., UE-to-Network Relay UE) 100-RL and NG-RAN 100-NN on the legs 722, 724′ and 724″. The RL radio device (e.g., UE-to-Network Relay UE) 100-RL forwards all the data messages between the RM radio device (e.g., Remote UE) 100-RM and NG-RAN 100-NN using the RAN specified L2 relay method.

Any embodiment disclosed herewith may meet one or more objective defined for a 3GPP Release 17 study item (SI) on NR sidelink relay in the 3GPP contribution RP-193253 and/or the below objectives and/or objective studied during 3GPP Release 17 time frame.

The technique may be implemented in fulfilment of study item targets, e.g., to study single-hop NR sidelink-based relay, optionally at least one of:
1. Study one or more mechanisms with minimum specification impact to support the SA requirements for sidelink-based UE-to-network and UE-to-UE relay, focusing on the following aspects (if applicable) for layer-3 relay and layer-2 relay:
   A. Relay (re-)selection criterion and procedure;
   B. Relay/Remote UE authorization;
   C. QoS for relaying functionality;
   D. Service continuity;
   E. Security of relayed connection after SA3 has provided its conclusions;
   F. Impact on user plane protocol stack and control plane procedure, e.g., connection management of relayed connection.
2. Study one or more mechanisms to support upper layer operations of discovery model/procedure for sidelink relaying, assuming no new physical layer channel or signal.
NOTE 1: The study shall take into account further input from SA WGs, e.g., SA2 and SA3, for the bullets above (if applicable).
NOTE 2: It is assumed that UE-to-network relay and UE-to-UE relay use the same relaying solution.
NOTE 3: Forward compatibility for multi-hop relay support in a future release needs to be taken into account.

According to the above study objectives, SL based radio device-to-network and/or UE-to-network (U2N) relay and radio device-to-radio device and/or UE to UE (U2U) relay is envisaged to be studied. The study will also consider forward compatibility, e.g., the solution may be easily extended to be applicable for multi-hop relay.

Embodiments are described in the context of NR, e.g., the RM radio device (e.g., Remote UE) 100-RM and the RL radio device (e.g., relay UE) 100-RL are deployed in a same or different NR cell, e.g. cell 302 in FIG. 3. The embodiments are also applicable to other relay scenarios including radio device (e.g., UE) to network relay or radio device (e.g., UE) to radio device (e.g., UE) relay where the RM radio device (e.g., Remote UE) 100-RM and the RL radio device (e.g., relay UE) 100-RL may be based on LTE SL and/or NR SL, the Uu connection between the RL radio device (e.g. relay UE) and the RAN (e.g., base station) 100-NN may be LTE Uu or NR Uu. A relay scenario containing multiple relay hops is also covered. The connection between a RM radio device (e.g. Remote UE) 100-RM and a RL radio device (e.g. relay UE) 100-RL is also not limited to a SL. Any short range communication technology, such as Wi-Fi, is equally applicable.

In the below embodiments, for illustrative purposes any grant issued by the RAN (e.g., gNB) 100-NN is referring to a SL transmission between two radio devices (e.g. UEs).

The embodiments are also applicable to a relay scenario where the RL radio device (e.g., relay UE) 100-RL is configured with multiple connections (e.g., the number of connections is equal to or larger than two) to the RAN 100-NN (e.g., dual connectivity and/or carrier aggregation, etc.).

The embodiments are applicable to both L2 relay and L3 relay.

In a first embodiment, for a RM radio device (e.g. Remote UE) 100-RM connecting to a RL radio device (e.g., relay UE) 100-RL which has coverage to a RAN (e.g., gNB) 100-NN, the RAN (e.g., gNB) 100-NN assigns grants to the RM radio device (e.g. Remote UE) via the RL radio device (e.g., relay UE) 100-RL.

According to the first embodiment, the RAN (e.g., gNB) 100-NN learns that the RM radio device (e.g., Remote UE) 100-RM demands resources for the SL between the RM radio device (e.g., Remote UE) 100-RM and the RL radio device (e.g., relay UE) 100-RL. Since the RM radio device (e.g., Remote UE) 100-RM may have no direct connection to the RAN (e.g., gNB) 100-NN, the RAN (e.g., gNB) 100-NN cannot assign resources to the RM radio device (e.g., Remote UE) 100-RM via a direct DL signaling. in this case, the RAN (e.g., gNB) 100-NN assigns a grant to the RM radio device (e.g., Remote UE) 100-RM via the RL radio device (e.g., relay UE) 100-RL. The Ran (e.g., gNB) 100-NN may apply at least one of the below options.
Option 1: a DCI addressed to the RL radio device (e.g., relay UE) 100-RL (e.g., addressed to RL UE's specific RNTI) carries a grant and an indicator indicating the grant is for the RM radio device (e.g., Remote UE) 100-RM. The indicator can be an explicit or inexplicit identifier of the RM radio device (e.g., Remote UE) 100-RM. The indicator may occupy one or multiple R fields if possible. The indicator may occupy bits of existing fields.
Option 2: a DCI addressed to the RL radio device (e.g., relay UE) 100-RL (e.g., addressed to RL UE's specific RNTI) carries a grant, however, it doesn't carry an indicator indicating the grant is for the RM radio device (e.g., Remote UE) 100-RM. Instead, whether or not the grant carried by the DCI is intended to the RM radio device (e.g., Remote UE) 100-RM, is indicated via other information such as
   1) specific frequency and/or time domain resources on which the DCI is transmitted
   2) specific DMRS sequence or PDCCH search space
Option 3: a specific RNTI is defined for the RM radio device (e.g., UE) 100-RM. However, the RNTI is not only monitored by the RM radio device (e.g., Remote UE) 100-RM, but also monitored by the RL radio device (e.g., relay UE) 100-RL. The RAN (e.g., gNB) 100-NN therefore sends a DCI signaling addressed to this specific RNTI. In case the RM radio device (e.g., Remote UE) 100-RM has no direct connection to the RAN (e.g., gNB) 100-NN, the RL radio node (e.g., relay UE) 100-RL can decode this DCI to obtain the grant for the RM radio node (e.g., UE) 100-RM.
Option 4: the RAN (e.g., gNB) 100-NN assigns a grant to the RM radio device (e.g. Remote UE) via a RRC signaling or a MAC CE.

For any of the above Options, if there are multiple RM radio devices (e.g., Remote UEs) who connect to the RAN (e.g., gNB) 100-NN via the same RL radio device (e.g., relay UE), the RAN (e.g., gNB) 100-NN may assign grants to multiple RM radio devices (e.g. Remote UEs) via the RL radio device (e.g., relay UE) in a same signaling message (according to any of the above Options). Alternatively or in addition, in order to reduce the signaling overhead, one or multiple bitmap fields may be carried by the signaling message for indicating identifiers of the RM radio device (e.g., Remote UE) 100-RM and/or the assigned grants. The bitmap field may also be applied to indicate time or frequency domain resources associated with the grants.

For any of the above Options, in case the RL radio device (e.g., relay UE) 100-RL needs to relay the grants to a RM radio device (e.g. Remote UE) 100-RM, the RL radio device (e.g., relay UE) may apply at least one of the below signaling alternatives:
Alt. 1: a RRC signaling (e.g., PC5-RRC signaling);
Alt. 2: a MAC CE;
Alt. 3: a L1 signaling (e.g., SCI signaling).

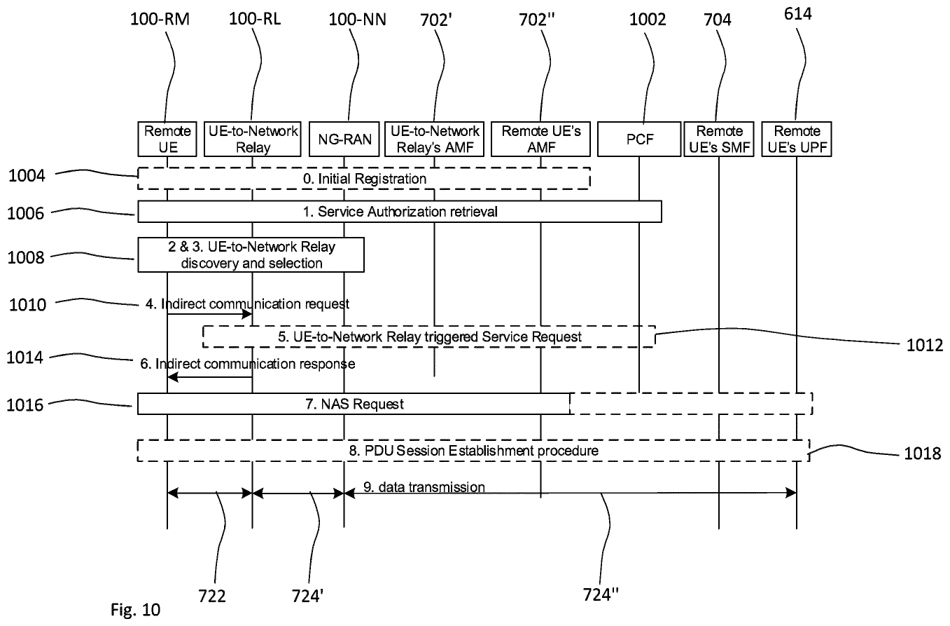

An example of the first embodiment is illustrated in FIG. 11, wherein the RAN (e.g., gNB) 100-NN transmits 206-NN individual grants for two RM radio devices (e.g., Remote UEs) 100-RM to a RL radio device (e.g., relay UE) 100-RL, which forwards the grants at reference sign 208-RL to each of the RM radio devices (e.g., Remote UEs) 100-RM.

According to a second embodiment, which is combinable with any other embodiment disclosed herein, for a RM radio device (e.g. Remote UE) 100-RM connecting to a RL radio device (e.g. relay UE) 100-RL which has coverage to a RAN (e.g., gNB) 100-NN, the RAN (e.g., gNB) 100-NN assigns a grant which can be shared between the RL radio device (e.g. relay UE) 100-RL and the RM radio device (e.g., relay UE) 100-RL. In case the RM radio device (e.g., Remote UE) 100-RM has no direct connection to the RAN (e.g., gNB) 100-NN, the RAN (e.g., gNB) 100-NN signals the grant to the RL radio device (e.g., relay UE) 100-RL via system information, dedicated RRC signaling, MAC CE or DCI. Grant sharing is performed given the fact that bi-directional traffic is typically carried on a SL RB between the RL radio device (e.g., relay UE) 100-RL and the RM radio device (e.g., relay UE) 100-RL. The RL radio device (e.g., relay UE) 100-RL and the RM radio device (e.g., Remote UE) 100-RM will not transmit on the SL RB at the same time. Whenever the RM radio device (e.g., Remote UE) 100-RM transmits a packet to the RL radio device (e.g., relay UE) 100-RL, the RL radio device (e.g., relay UE) 100-RL may need to provide an acknowledgement (e.g., an ACK) on the reverse link. So, the RAN (e.g., gNB) 100-NN can assign a shared grant for one or multiple SL RBs with bi-directional traffic. While for a unidirectional SL RB, the RAN (e.g., gNB) 100-NN may assign a non-shared grant.

According to the second embodiment, if the shared grant is signaled by a DCI, it is enough for the RAN (e.g., gNB) 100-NN to send the DCI addressed to a RL radio device's (e.g., relay UE's) 100-RL RNTI.

The grant signaling may also need to carry the RM radio device (e.g., Remote UE) IDs indicating the RM radio devices (e.g., Remote UEs) 100-RM with which the RL radio device (e.g., relay UE) 100-RL needs to share the grant.

For a shared grant, the RAN (e.g., gNB) 100-NN configures a sharing configuration between a RM radio device (e.g., Remote UE) 100-RM and a RL radio device (e.g., relay UE) 100-RL. The shared grant may be valid for a configured time period which contains multiple transmission occasions. The sharing configuration indicates at least one of the below information.
1) For each transmission occasion (e.g., each occasion spans a number of consecutive OFDM symbols or consecutive slots) during the valid period, it is the RM radio device (e.g., Remote UE) 100-RM or the RL radio device (e.g., relay UE) 100-RL that is allowed to perform transmission using the grant. In case the occasion is allocated to the RM radio device (e.g., Remote UE) 100-RM, the RM radio device (e.g., Remote UE) 100-RM can initiate an SL transmission to the RL radio device (e.g., relay UE) 100-RL on the associated SL RB, using the grant. In case the occasion is allocated to the RL radio device (e.g., relay UE) 100-RL, the RL radio device (e.g., relay UE) 100-RL can initiate an SL transmission to the RM radio device (e.g., Remote UE) 100-RM on the associated SL RB using the grant.
2) For each transmission occasion (e.g., each occasion spans a number of consecutive OFDM symbols or consecutive slots) during the valid period, what type of transmission (e.g., control signaling or data) is allowed to be transmitted using the grant.

There may be one or multiple flexible transmission occasions during the valid period. Each flexible transmission occasion can be used by the RM radio device (e.g., Remote UE) 100-RM or the RL radio device (e.g., relay UE) 100-RL depending on needs.

There may be multiple sharing configurations configured to the RM radio device (e.g., Remote UE) 100-RM and the RL radio device (e.g., relay UE) 100-RL by the RAN (e.g., gNB) 100-NN. Each configuration may give and/or specify different portions of transmission occasions for the RM radio device (e.g., Remote UE) 100-RM and the RL radio device (e.g., relay UE) 100-RL.

Each (e.g., sharing) configuration may be also named as a pattern. Each (e.g., sharing) configuration and/or pattern may be associated with a unique index. The RAN (e.g., gNB) 100-NN can adopt at least one of the below options to signal the (e.g., sharing) configuration/pattern.
Option 1: the RAN (e.g., gNB) 100-NN configures one single sharing configuration to one relay pair (e.g., a RM radio device 100-RM and a RL radio device 100-RL). The configuration is applied for one or multiple SL RBs between the RM radio device (e.g., Remote UE) 100-RM and the RL radio device (e.g., relay UE) 100-RL. For each shared grant, the RM radio device (e.g., Remote UE) 100-RM and the RL radio device (e.g., relay UE) 100-RL determines the transmission occasions which are allocated to them respectively based on the sharing configuration. In case the RAN (e.g., gNB) 100-NN would like to change to a different sharing configuration, the RAN (e.g., gNB) 100-NN needs to signal the new configuration to the RM radio device (e.g., Remote UE) and the RL radio device (e.g., UE).
Option 2: the RAN (e.g., gNB) 100-NN configures multiple single sharing configurations to one relay pair (e.g., a RM radio device 100-RM and a RL radio device 100-RL). In this case, for each shared grant, the RAN (e.g., gNB) 100-NN can decide which configuration is applied. The RAN (e.g., gNB) 100-NN may signal both a grant and an associated sharing configuration to the relay pair.

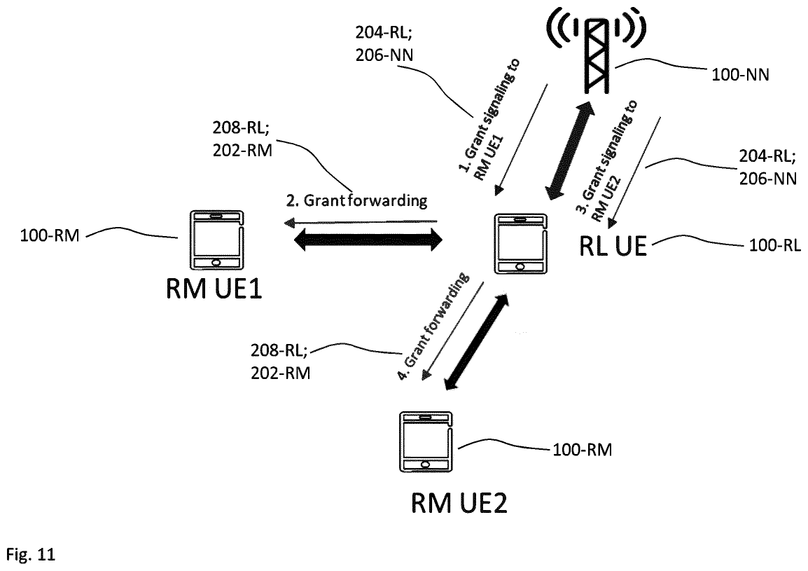

An example of the second embodiment is illustrated in FIG. 12, wherein the RAN (e.g., eNB) 100-NN signals 206-NN a (e.g., shared) grant to a RL radio device (e.g., relay UE) 100-RL for relaying 208-RL to two RM radio devices (e.g., Remote UEs) 100-RM. The grant may be shared between the RL radio device (e.g., relay UE) 100-RL and the RM radio devices (e.g., Remote UEs) 100-RM.

According to a third embodiment, which is combinable with any other embodiment disclosed herein, if multiple RM radio devices (e.g., Remote UEs) 100-RM connecting to a RL radio device (e.g., relay UE) which has coverage to a RAN (e.g., gNB) 100-NN, the RAN (e.g., gNB) 100-NN assigns a grant which can be shared between the RL radio device (e.g., relay UE) 100-RL and the RM radio devices (e.g., Remote UEs) 100-RM.

Similar as for the second embodiment, according to the third embodiment the RAN (e.g., gNB) 100-NN may configure one or multiple sharing configurations indicating transmission occasion and/or slot allocation between the RL radio device (e.g., relay UE) 100-RL and the RM radio devices (e.g., Remote UEs) 100-RM for one or multiple bidirectional SL RBs.

According to a fourth embodiment, which is combinable with any other embodiment disclosed herein, a radio device (e.g., UE) capability bit may be defined for indicating whether the radio device (e.g., UE) supports shared grant with another radio device (e.g., UE) in case of a relay scenario. Different capability bits for indicating whether the radio device (e.g., UE) supports shared grant with another radio device (e.g., UE) may be defined for RM radio device (e.g., Remote UE) 100-RM and RL radio device (e.g., relay UE) 100-RL, respectively.

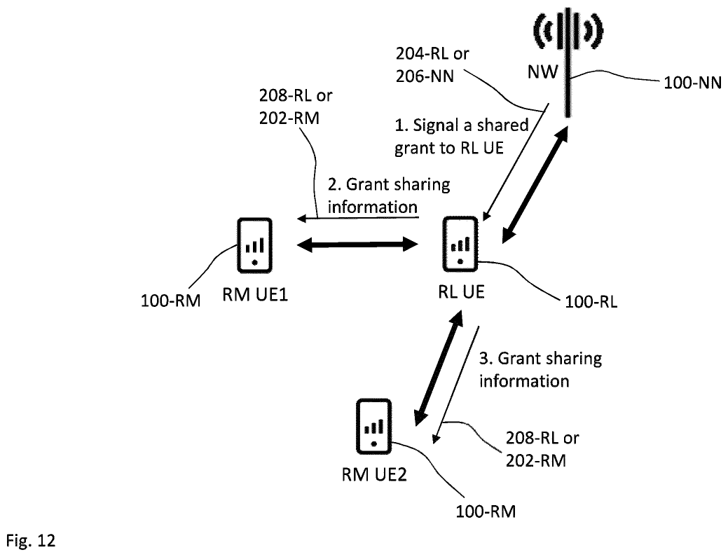

FIG. 13A shows a schematic block diagram for an embodiment of the device 100-RL. The device 100-RL comprises one or more processors 1304-RL for performing the method 200-RL and memory 1306-RL coupled to the processors 1304-RL. For example, the memory 1306-RL may be encoded with instructions that implement at least one of the units 102-RL, 104-RL, 106-RL, 108-RL, 110-RL, 112-RL and 114-RL.

The one or more processors 1304-RL may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100-RL, such as the memory 1306-RL, transmitter functionality. For example, the one or more processors 1304-RL may execute instructions stored in the memory 1306-RL. Such functionality may include providing various features and steps discussed herein, including any of the benefits disclosed herein. The expression “the device being operative to perform an action” may denote the device 100-RL being configured to perform the action.

As schematically illustrated in FIG. 13A, the device 100-RL may be embodied by a RL radio device 1300-RL, e.g., functioning as a base station or UE. The RL radio device 1300-RL comprises a radio interface 1302-RL coupled to the device 100-RL for radio communication with one or more base stations or UEs.

FIG. 13B shows a schematic block diagram for an embodiment of the device 100-NN. The device 100-NN comprises one or more processors 1304-NN for performing the method 100-NN and memory 1306-NN coupled to the processors 1304-NN. For example, the memory 1306-NN may be encoded with instructions that implement at least one of the units 102-NN, 104-NN and 106-NN.

The one or more processors 1304-NN may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100-NN, such as the memory 1306-NN, receiver functionality. For example, the one or more processors 1304-NN may execute instructions stored in the memory 1306-NN. Such functionality may include providing various features and steps discussed herein, including any of the benefits disclosed herein. The expression “the device being operative to perform an action” may denote the device 100-NN being configured to perform the action.

As schematically illustrated in FIG. 13B, the device 100-NN may be embodied by a network node 1300-NN, e.g., functioning as a base station or UE. The network node 1300-NN comprises a radio interface 1302-NN coupled to the device 100-NN for radio communication with one or more base stations or UEs.

FIG. 13C shows a schematic block diagram for an embodiment of the device 100-RM. The device 100-RM comprises one or more processors 1304-RM for performing the method 200-RM and memory 1306-RM coupled to the processors 1304-RM. For example, the memory 1306-RM may be encoded with instructions that implement at least one of the units 102-RM, 104-RM, 106-RM and 108-RL.

The one or more processors 1304-RM may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100-RM, such as the memory 1306-RM, transmitter functionality. For example, the one or more processors 1304-RM may execute instructions stored in the memory 1306-RM. Such functionality may include providing various features and steps discussed herein, including any of the benefits disclosed herein. The expression “the device being operative to perform an action” may denote the device 100-RM being configured to perform the action.

As schematically illustrated in FIG. 13C, the device 100-RM may be embodied by a RM-radio device 1300-RM, e.g., functioning as a base station or UE. The RL radio device 1300-RM comprises a radio interface 1302-RM coupled to the device 100-RM for radio communication with one or more base stations or UEs.

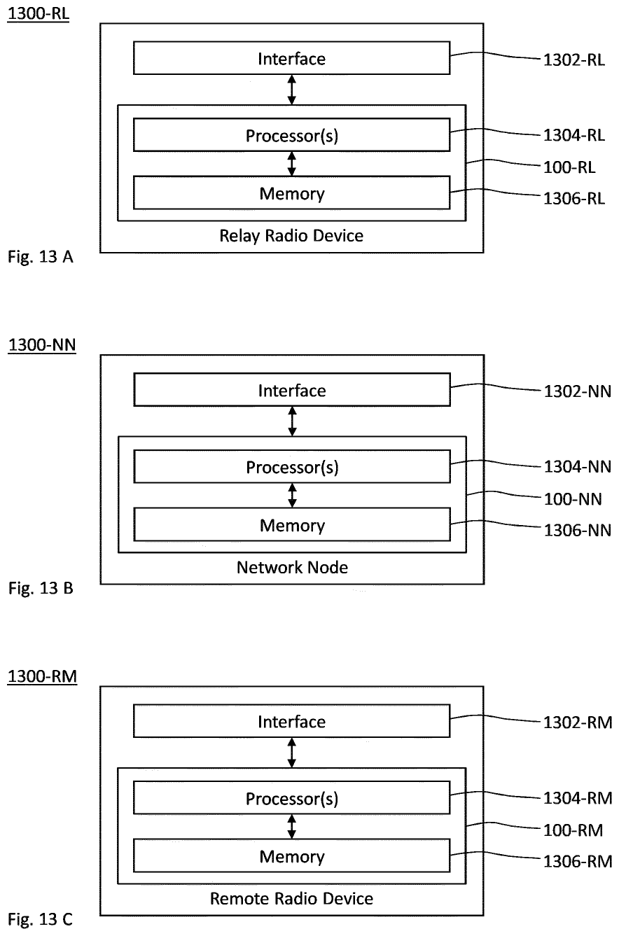

With reference to FIG. 14, in accordance with an embodiment, a communication system 1400 includes a telecommunication network 1410, such as a 3GPP-type cellular network, which comprises an access network 1411, such as a radio access network, and a core network 1414. The access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to the core network 1414 over a wired or wireless connection 1415. A first user equipment (UE) 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

The telecommunication network 1410 is itself connected to a host computer 1430, which may be embodied in the hardware and/or software of a standalone server, a cloud-implemented server, a distributed server or as processing resources in a server farm. The host computer 1430 may be under the ownership or control of a service provider, or may be operated by the service provider or on behalf of the service provider. The connections 1421, 1422 between the telecommunication network 1410 and the host computer 1430 may extend directly from the core network 1414 to the host computer 1430 or may go via an optional intermediate network 1420. The intermediate network 1420 may be one of, or a combination of more than one of, a public, private or hosted network; the intermediate network 1420, if any, may be a backbone network or the Internet; in particular, the intermediate network 1420 may comprise two or more sub-networks (not shown).

The communication system 1400 of FIG. 14 as a whole enables connectivity between one of the connected UEs 1491, 1492 and the host computer 1430. The connectivity may be described as an over-the-top (OTT) connection 1450. The host computer 1430 and the connected UEs 1491, 1492 are configured to communicate data and/or signaling via the OTT connection 1450, using the access network 1411, the core network 1414, any intermediate network 1420 and possible further infrastructure (not shown) as intermediaries. The OTT connection 1450 may be transparent in the sense that the participating communication devices through which the OTT connection 1450 passes are unaware of routing of uplink and downlink communications. For example, a base station 1412 need not be informed about the past routing of an incoming downlink communication with data originating from a host computer 1430 to be forwarded (e.g., handed over) to a connected UE 1491. Similarly, the base station 1412 need not be aware of the future routing of an outgoing uplink communication originating from the UE 1491 towards the host computer 1430.

By virtue of the methods 200-RL, 200-NN and 200-RM being performed by any one of the UEs 1491 or 1492 and/or any one of the base stations 1412, the performance of the OTT connection 1450 can be improved, e.g., in terms of increased throughput and/or reduced latency.

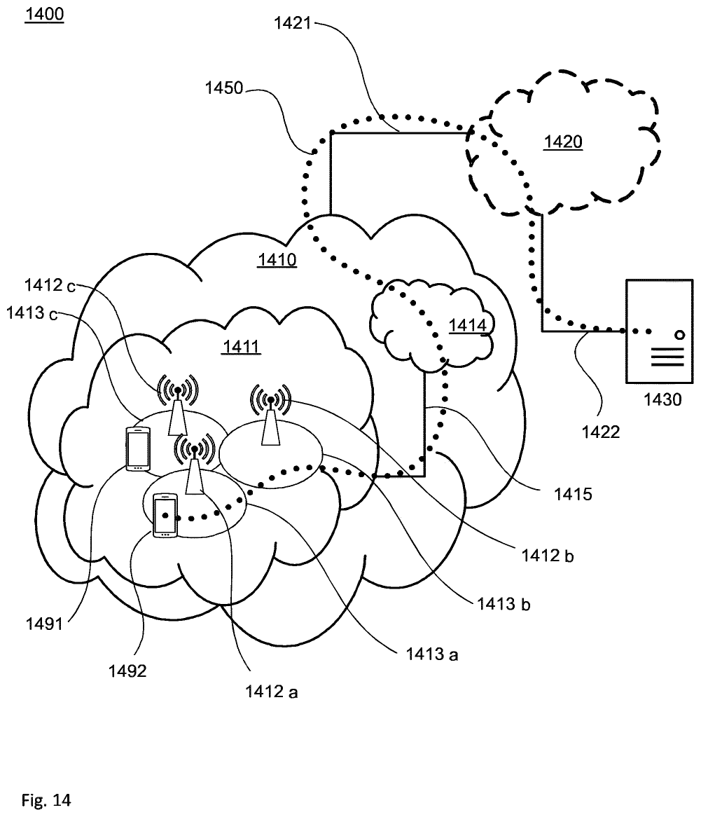

Example implementations, in accordance with an embodiment, of the UE, base station and host computer discussed in the preceding paragraphs will now be described with reference to FIG. 15. In a communication system 1500, a host computer 1510 comprises hardware 1515 including a communication interface 1516 configured to set up and maintain a wired or wireless connection with an interface of a different communication device of the communication system 1500. The host computer 1510 further comprises processing circuitry 1518, which may have storage and/or processing capabilities. In particular, the processing circuitry 1518 may comprise one or more programmable processors, application-specific integrated circuits, field programmable gate arrays or combinations of these (not shown) adapted to execute instructions. The host computer 1510 further comprises software 1511, which is stored in or accessible by the host computer 1510 and executable by the processing circuitry 1518. The software 1511 includes a host application 1512. The host application 1512 may be operable to provide a service to a remote user, such as a UE 1530 connecting via an OTT connection 1550 terminating at the UE 1530 and the host computer 1510. In providing the service to the remote user, the host application 1512 may provide user data, which is transmitted using the OTT connection 1550. The user data may depend on the location of the UE 1530. The user data may comprise auxiliary information or precision advertisements (also: ads) delivered to the UE 1530. The location may be reported by the UE 1530 to the host computer, e.g., using the OTT connection 1550, and/or by the base station 1520, e.g., using a connection 1560.

The communication system 1500 further includes a base station 1520 provided in a telecommunication system and comprising hardware 1525 enabling it to communicate with the host computer 1510 and with the UE 1530. The hardware 1525 may include a communication interface 1526 for setting up and maintaining a wired or wireless connection with an interface of a different communication device of the communication system 1500, as well as a radio interface 1527 for setting up and maintaining at least a wireless connection 1570 with a UE 1530 located in a coverage area (not shown in FIG. 15) served by the base station 1520. The communication interface 1526 may be configured to facilitate a connection 1560 to the host computer 1510. The connection 1560 may be direct or it may pass through a core network (not shown in FIG. 15) of the telecommunication system and/or through one or more intermediate networks outside the telecommunication system. In the embodiment shown, the hardware 1525 of the base station 1520 further includes processing circuitry 1528, which may comprise one or more programmable processors, application-specific integrated circuits, field programmable gate arrays or combinations of these (not shown) adapted to execute instructions. The base station 1520 further has software 1521 stored internally or accessible via an external connection.

The communication system 1500 further includes the UE 1530 already referred to. Its hardware 1535 may include a radio interface 1537 configured to set up and maintain a wireless connection 1570 with a base station serving a coverage area in which the UE 1530 is currently located. The hardware 1535 of the UE 1530 further includes processing circuitry 1538, which may comprise one or more programmable processors, application-specific integrated circuits, field programmable gate arrays or combinations of these (not shown) adapted to execute instructions. The UE 1530 further comprises software 1531, which is stored in or accessible by the UE 1530 and executable by the processing circuitry 1538. The software 1531 includes a client application 1532. The client application 1532 may be operable to provide a service to a human or non-human user via the UE 1530, with the support of the host computer 1510. In the host computer 1510, an executing host application 1512 may communicate with the executing client application 1532 via the OTT connection 1550 terminating at the UE 1530 and the host computer 1510. In providing the service to the user, the client application 1532 may receive request data from the host application 1512 and provide user data in response to the request data. The OTT connection 1550 may transfer both the request data and the user data. The client application 1532 may interact with the user to generate the user data that it provides.

It is noted that the host computer 1510, base station 1520 and UE 1530 illustrated in FIG. 15 may be identical to the host computer 1430, one of the base stations 1412a, 1412b, 1412c and one of the UEs 1491, 1492 of FIG. 14, respectively. This is to say, the inner workings of these entities may be as shown in FIG. 15 and independently, the surrounding network topology may be that of FIG. 14.

In FIG. 15, the OTT connection 1550 has been drawn abstractly to illustrate the communication between the host computer 1510 and the use equipment 1530 via the base station 1520, without explicit reference to any intermediary devices and the precise routing of messages via these devices. Network infrastructure may determine the routing, which it may be configured to hide from the UE 1530 or from the service provider operating the host computer 1510, or both. While the OTT connection 1550 is active, the network infrastructure may further take decisions by which it dynamically changes the routing (e.g., on the basis of load balancing consideration or reconfiguration of the network).

The wireless connection 1570 between the UE 1530 and the base station 1520 is in accordance with the teachings of the embodiments described throughout this disclosure. One or more of the various embodiments improve the performance of OTT services provided to the UE 1530 using the OTT connection 1550, in which the wireless connection 1570 forms the last segment. More precisely, the teachings of these embodiments may reduce the latency and improve the data rate and thereby provide benefits such as better responsiveness.

A measurement procedure may be provided for the purpose of monitoring data rate, latency and other factors on which the one or more embodiments improve. There may further be an optional network functionality for reconfiguring the OTT connection 1550 between the host computer 1510 and UE 1530, in response to variations in the measurement results. The measurement procedure and/or the network functionality for reconfiguring the OTT connection 1550 may be implemented in the software 1511 of the host computer 1510 or in the software 1531 of the UE 1530, or both. In embodiments, sensors (not shown) may be deployed in or in association with communication devices through which the OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of the OTT connection 1550 may include message format, retransmission settings, preferred routing etc.; the reconfiguring need not affect the base station 1520, and it may be unknown or imperceptible to the base station 1520. Such procedures and functionalities may be known and practiced in the art. In certain embodiments, measurements may involve proprietary UE signaling facilitating the host computer's 1510 measurements of throughput, propagation times, latency and the like. The measurements may be implemented in that the software 1511, 1531 causes messages to be transmitted, in particular empty or “dummy” messages, using the OTT connection 1550 while it monitors propagation times, errors etc.

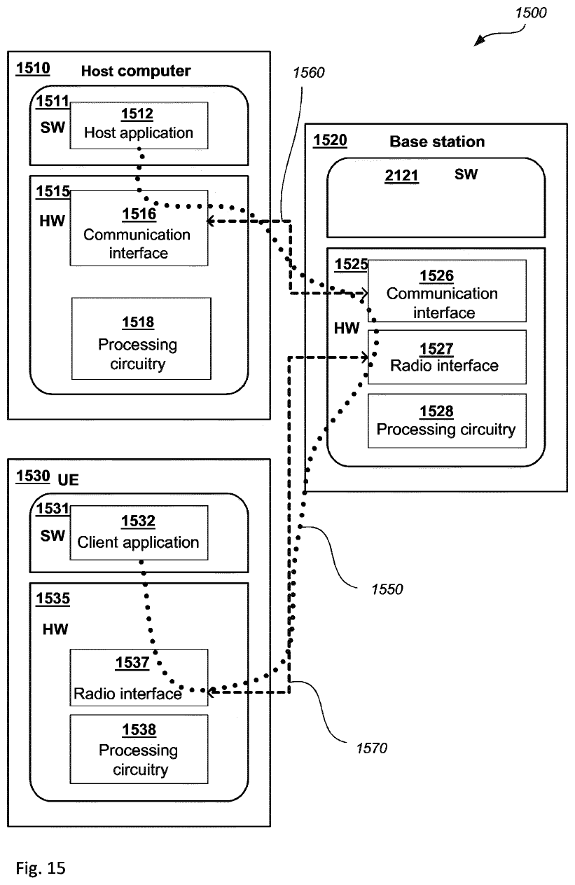

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In a first step 1610 of the method, the host computer provides user data. In an optional substep 1611 of the first step 1610, the host computer provides the user data by executing a host application. In a second step 1620, the host computer initiates a transmission carrying the user data to the UE. In an optional third step 1630, the base station transmits to the UE the user data which was carried in the transmission that the host computer initiated, in accordance with the teachings of the embodiments described throughout this disclosure. In an optional fourth step 1640, the UE executes a client application associated with the host application executed by the host computer.

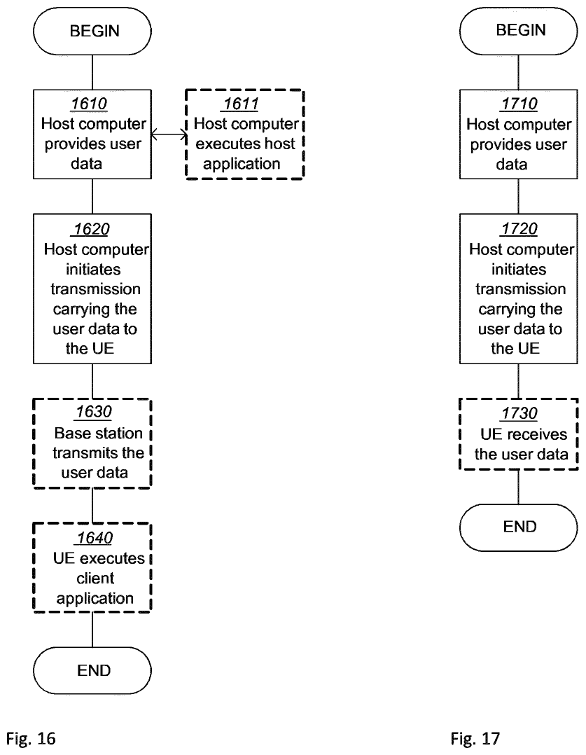

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In a first step 1710 of the method, the host computer provides user data. In an optional substep (not shown) the host computer provides the user data by executing a host application. In a second step 1720, the host computer initiates a transmission carrying the user data to the UE. The transmission may pass via the base station, in accordance with the teachings of the embodiments described throughout this disclosure. In an optional third step 1730, the UE receives the user data carried in the transmission.

As has become apparent from above description, embodiments of the technique allow for a network node (e.g., a gNB) to signal a grant to a RM radio device (e.g., a remote UE) in a relay scenario, even if there is no direct connection between the network node (e.g., gNB) and the RM radio device (e.g., remote UE). Alternatively or in addition, a flexible resource allocation mechanism may be achieved for a RM radio device (e.g., remote UE). Further alternatively or in addition, resource utilization efficiency may be improved for a RM radio device (e.g., remote UE) in case of a relay scenario.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1-49. (canceled)

50. A method of receiving a radio resource allocation at a relay radio device for at least one remote radio device in relayed radio communication with a radio access network (RAN) or a further radio device through the relay radio device, the method comprising:
receiving, at the relay radio device, a control message indicative of radio resources allocated to a device-to-device (D2D) communication between the at least one remote radio device and the relay radio device; and
wherein the allocated radio resources are shared between the relay radio device and the remote radio device.

51. The method of claim 50, wherein the control message is indicative of the at least one remote radio device or one of the at least one remote radio device to which the radio resources are allocated, or wherein the control message comprises a bit field of at least one bit indicative of the at least one remote radio device.

52. The method of claim 50, wherein the control message is indicative of a remote radio device by at least one of:
a time domain and/or a frequency domain in which the control message is transmitted;
a demodulation reference signal (DM-RS) sequence;
a search space of a physical channel on which the control message is transmitted, preferably a search space of a physical downlink control channel (PDCCH); and
a radio network temporary identifier (RNTI) to which the control message is addressed.

53. The method of claim 50, further comprising:
selecting, from a plurality of allocated radio resources received in the control message, radio resources to be used for the D2D communication between the relay radio device and the at least one remote radio device or one of the at least one remote radio device.

54. The method of claim 50, further comprising:
transmitting, from the relay radio device to the remote radio device, a grant for a data transmission from the remote radio device to the relay radio device, wherein the grant is comprised in the radio resource allocation received at the relay radio device;
receiving at the relay radio device the data transmission on the allocated radio resources from the remote radio device to be relayed to the RAN or the further radio device; and
transmitting, from the relay radio device to the remote radio device, an acknowledgment indicative of at least one of the reception of the data transmission and a relaying of the data transmission to the RAN or the further radio device.

55. The method of claim 50, wherein:
the at least one remote radio device comprises at least two remote radio devices; and
the control message indicative of the radio resources comprises the radio resource allocations for both or each of the at least two remote radio devices.

56. The method of claim 50, wherein the control message indicative of the allocated radio resources is further indicative of at least one radio resource being allocated for a predetermined time period, number of transmission occasions, and/or number of data packets.

57. The method of claim 50, further comprising:
transmitting, from the relay radio device, a capability message indicative of the relay radio device being capable of at least one of relaying the allocation of the radio resources and sharing the allocated radio resources.

58. The method of claim 50, further comprising:
receiving, from the remote radio device, a scheduling request for the relayed radio communication; and
responsive to the scheduling request received from the remote radio device, transmitting a scheduling grant for the allocated radio resources or a subset of the allocated radio resources to the at least one remote radio device or forwarding the scheduling request to the RAN or the further radio device.

59. A method of transmitting a radio resource allocation to a relay radio device for at least one remote radio device in relayed radio communication with a radio access network (RAN) or a further radio device through the relay radio device, the method comprising:
allocating radio resources to a device-to-device (D2D) communication between the at least one remote radio device and the relay radio device;
transmitting, to the relay radio device, a control message indicative of the radio resources allocated to the D2D communication between the at least one remote radio device and the relay radio device; and
wherein the allocated radio resources are shared between the relay radio device and the remote radio device.

60. The method of claim 59, wherein the control message is indicative of the at least one remote radio device or one of the at least one remote radio device to which the radio resources are allocated, or wherein the control message comprises a bit field of at least one bit indicative of the at least one remote radio device.

61. The method of claim 59, wherein the control message is indicative of the at least one remote radio device or one of the at least one remote radio device to which the radio resources are allocated by at least one of:
a time domain and/or a frequency domain in which the control message is transmitted;
a demodulation reference signal (DM-RS) sequence;
a search space of a physical channel on which the control message is transmitted, preferably a search space of a physical downlink control channel (PDCCH); and
a radio network temporary identifier (RNTI) to which the control message is addressed.

62. The method of claim 59, further comprising:
selecting, from a plurality of radio resources to be used for the D2D communication between the relay radio device and the at least one remote radio device or one of the at least one remote radio device.

63. The method of claim 59, further comprising:
receiving, from the relay radio device, a grant for a data transmission from the remote radio device to the relay radio device, wherein the grant is comprised in the radio resource allocation received at the relay radio device;
transmitting to the relay radio device a data transmission on the allocated radio resources from the remote radio device to be relayed to the RAN or the further radio device; and
receiving, from the relay radio device to the remote radio device, an acknowledgment indicative of at least one of the reception of the data transmission and a relaying of the data transmission to the RAN or the further radio device.

64. The method of claim 59, wherein:
the at least one remote radio device comprises at least two remote radio devices; and
the control message indicative of the radio resources comprises the radio resource allocations for both or each of the at least two remote radio devices.

65. The method of claim 59, wherein the control message indicative of the allocated radio resources is further indicative of at least one radio resource being allocated for a predetermined time period, number of transmission occasions, and/or number of data packets.

66. The method of claim 59, further comprising:
receiving, from the relay radio device, a capability message indicative of the relay radio device being capable of at least one of relaying the allocation of the radio resources and sharing the allocated radio resources.

67. The method of claim 59, further comprising:
transmitting, to the relay radio device, a scheduling request for the relayed radio communication; and
responsive to transmitting the scheduling request, receiving, from the relay radio device, a scheduling grant for the allocated radio resources or a subset of the allocated radio resources to the at least one remote radio device or forwarding the scheduling request to the RAN or the further radio device.

68. A device for receiving a radio resource allocation at a relay radio device for at least one remote radio device in relayed radio communication with a radio access network (RAN) or a further radio device through the relay radio device, the device comprising:
a memory operable to store instructions and processing circuitry operable to execute the instructions, whereby the device is operative to:
receive, at the relay radio device, a control message indicative of radio resources allocated to a device-to-device (D2D) communication between the at least one remote radio device and the relay radio device; and
wherein the allocated radio resources are shared between the relay radio device and the remote radio device.

69. A device for transmitting a radio resource allocation to a relay radio device for at least one remote radio device in relayed radio communication with a radio access network (RAN) or a further radio device through the relay radio device, the device comprising:
a memory operable to store instructions and processing circuitry operable to execute the instructions, whereby the device is operative to:
allocate radio resources to a device-to-device (D2D) communication between the at least one remote radio device and the relay radio device;
transmit, to the relay radio device, a control message indicative of the radio resources allocated to the D2D communication between the at least one remote radio device and the relay radio device; and
wherein the allocated radio resources are shared between the relay radio device and the remote radio device.
